(19) United States
(12) Patent Application Publication
(10) Pub. No.: US 2013/0321348 A1
(43) Pub. Date: Dec. 5, 2013

(54) PEN TABLET DEVICE, AND PEN TABLET SYSTEM

(71) Applicant: Kengo Takahama, Osaka-shi (JP)

(72) Inventor: Kengo Takahama, Osaka-shi (JP)

(73) Assignee: SHARP KABUSHIKI KAISHA, Osaka-shi, Osaka (JP)

(21) Appl. No.: 13/985,668

(22) PCT Filed: Feb. 21, 2012
(86) PCT No.: PCT/JP2012/054132

§ 371 Date: Aug. 15, 2013

(30) Foreign Application Priority Data
Feb. 25, 2011 (JP) 2011 040635

(51) Int. Cl. G06F 3/0354

(52) U.S. Cl. CPC G06F 3/03545
USPC 345/177

(57) ABSTRACT

An ultrasonic detector (8) included in a pen (3) detects ultrasonic waves which (i) are emitted from respective plurality of ultrasonic emitters (5a, 5b) and (ii) are transmitted to the pen (3) via an ultrasonic transmission sheet (2) and a writing medium (6) while a tip of the pen (3) is in contact with the writing medium (6). A pen tablet device (i) carries out a calculation to find a correlation between each of signals based on the respective ultrasonic waves detected by the ultrasonic detector (8) and a corresponding one of independent pseudo-random signals to thereby find a delay time for a corresponding one of the plurality of ultrasonic emitters (5a, 5b) and (ii) finds the coordinates of the tip of the pen (3) from the delay time.

### TECHNICAL FIELD

The present invention relates to (i) a pen tablet device capable of detecting coordinates of a tip of a pen and (ii) a pen tablet system including the pen tablet device.

### BACKGROUND ART

In recent years, there have been commonly used electronic tablets (e.g., digitizer tablets), scanners, and the like which can convert a handwritten document or illustration into electronic data.

However, although there has been the following demand in hospitals etc., the demand has not been fully met at present. That is, doctors in hospitals record, on patients' charts or notebooks, patient's health conditions, medicines, mental conditions and behaviors by means of symbols and comments that are only understandable to specialists. There has been a demand to convert such handwritten documents into electronic data for management and search purposes.

The reasons therefore are as follows. An electronic tablet such as a digitizer tablet is not easy to use, because a user needs to see a screen of a personal computer while using the electronic tablet. On the other hand, a conventional technique using a scanner is very troublesome, because it is necessary to scan a handwritten document or illustration with the scanner after preparing the handwritten document or illustration.

That is, for busy healthcare workers, just handwriting is quicker. Therefore, it is not so advantageous for them to take time and trouble to convert handwritten letters and illustrations into electronic data.

Moreover, also as to implementation of an IT system in an entire hospital, there is no advantage in introducing a digital conversion system for the same reason. In particular, for financial reasons, it is difficult for a small hospital and the like to introduce such a digital conversion system.

In view of the circumstances, in various fields including the medical field described above, there is a strong demand for development of a pen tablet device that can record handwriting while converting the handwriting into electronic data. Such a device is being developed.

For example, Patent Literature 1 discloses a pen tablet device as illustrated in FIG. 22.

As illustrated in FIG. 22, a random pattern illustrated in an enlarged part 104 is printed on a paper 101, whereas a camera is included in a pen 102.

According to the above configuration, the pen 102 enables handwriting on the paper 101. Meanwhile, the camera in the pen 102 reads the random pattern. The pen 102 and an external device 103 analyze the random pattern read by the camera and detect coordinates corresponding to the random pattern. This allows for conversion of handwriting into electronic data.

### CITATION LIST

### Patent Literatures

Patent Literature 1
International Publication No. WO2004-097723 A (Publication Date: Nov. 11, 2004)

### SUMMARY OF INVENTION

### Technical Problem

However, according to the configuration disclosed in Patent Literature 1 (see FIG. 22), it is necessary that a random pattern be printed on the paper 101.

Therefore, the following problem arises. That is, according to the configuration, it is possible to record information by handwriting on a special sheet of paper on which the random pattern is printed, while converting the information into electronic data. However, in a case of using a regular sheet of paper or a notebook on which no random pattern is printed, even though information can be recorded by handwriting, it is not possible to covert the handwritten information into electronic data while recording the handwritten information.

The present invention was made in view of the above problems, and an object of the present invention is to provide (i) a pen tablet device which enables handwriting while converting the handwriting into electronic data even in a case where a regular sheet of paper or a notebook on which no pattern or the like is printed is used and (ii) a pen tablet system including the pen tablet device.

### Solution to Problem

In order to attain the above object, a pen tablet device of the present invention includes a pen; and a holder, said pen tablet device being capable of detecting coordinates of a tip of the pen, the pen (i) including a vibration detector and (ii) including, at the tip, a tip member which transmits vibration while in contact with a writing medium placed on the holder, the holder having, at its corners, three or more vibration emitters which emit respective independent pseudo-random signals, the vibration detector detecting vibrations which (i) are emitted from the respective three or more vibration emitters and (ii) are transmitted to the pen via the holder and the writing medium while the tip of the pen is in contact with the writing medium, and said pen tablet device (i) carrying out a calculation to find a correlation between each of signals based on the respective vibrations detected by the vibration detector and a corresponding one of the independent pseudo-random signals to thereby find a delay time for a corresponding one of the three or more vibration emitters and (ii) finding the coordinates of the tip of the pen from the delay time.

According to the arrangement, the pen includes, at the tip, the tip member which is to make contact with the writing medium. This enables handwriting on the writing medium.

Furthermore, according to the arrangement, the coordinates of the tip of the pen are detected in the following manner, and thereby handwriting is converted into electronic data. That is, the vibration detector included in the pen detects the vibrations (i.e., the respective independent pseudo-random signals) emitted from the respective plurality of vibration emitters. The pen tablet device (i) carries out a calculation to find a correlation between each of the signals based on the respective vibrations detected by the vibration detector and a corresponding one of the independent pseudo-random signals to thereby find a delay time for a corresponding one of the plurality of vibration emitters and (ii) finds the coordinates of the tip of the pen from the delay time.

As such, according to the arrangement, it is possible to provide a pen tablet device capable of recording handwriting while converting the handwriting into electronic data even in a case where the writing medium such as a regular sheet of paper or a notebook on which no pattern or the like is printed is used.

In order to attain the above object, a pen tablet device of the present invention includes a pen; and a holder, said pen tablet device being capable of detecting coordinates of a tip of the pen, the pen (i) including a vibration detector and (ii) including, at the tip, a tip member which transmits vibration while in contact with a writing medium placed on the holder, the holder having, at its corners, a plurality of vibration emitters which emit respective independent pseudo-random signals, the vibration detector detecting vibrations which (i) are emitted from the respective plurality of vibration emitters and (ii) are transmitted to the pen via the holder and the writing medium while the tip of the pen is in contact with the writing medium, a start pulse signal for the plurality of vibration emitters being in synchronization with a start pulse signal for the vibration detector, and said pen tablet device (i) carrying out a calculation to find a correlation between each of signals based on the respective vibrations detected by the vibration detector and a corresponding one of the independent pseudo-random signals to thereby find a delay time for a corresponding one of the plurality of vibration emitters and (ii) finding the coordinates of the tip of the pen from the delay time.

According to the arrangement, the start pulse signal for the vibration emitters is in synchronization with the start pulse signal for the vibration detector. This makes it possible to detect the coordinates of the tip of the pen even in a case where a smaller number of vibration emitters are provided.

A pen tablet system of the present invention includes the pen tablet device; and a processing device for processing information indicative of coordinates of the tip of the pen, the pen of the pen tablet device including a transmitting section for transmitting the information indicative of the coordinates of the tip of the pen, and the processing device including a receiving section for receiving the information indicative of the coordinates of the tip of the pen which information is transmitted from the transmitting section.

According to the arrangement, the pen of the pen tablet device includes the transmitting section for transmitting the information indicative of the coordinates of the tip of the pen, and the processing device includes the receiving section for receiving the information indicative of the coordinates of the tip of the pen which information is transmitted from the transmitting section.

This makes it possible to transmit, to the processing device, the information indicative of the coordinates of the tip of the pen detected in the pen.

### Advantageous Effects of Invention

As described above, the pen tablet device of the present invention includes a pen; and a holder, said pen tablet device being capable of detecting coordinates of a tip of the pen, the pen (i) including a vibration detector and (ii) including, at the tip, a tip member which transmits vibration while in contact with a writing medium placed on the holder, the holder having, at its corners, a plurality of vibration emitters which emit respective independent pseudo-random signals, the vibration detector detecting vibrations which (i) are emitted from the respective plurality of vibration emitters and (ii) are transmitted to the pen via the holder and the writing medium while the tip of the pen is in contact with the writing medium, and said pen tablet device (i) carrying out a calculation to find a correlation between each of signals based on the respective vibrations detected by the vibration detector and a corresponding one of the independent pseudo-random signals to thereby find a delay time for a corresponding one of the plurality of vibration emitters and (ii) finding the coordinates of the tip of the pen from the delay time.

As described above, the pen tablet device of the present invention includes the pen (i) including a vibration detector and (ii) including, at the tip, a tip member which transmits vibration while in contact with a writing medium placed on the holder, the holder having, at its corners, a plurality of vibration emitters which emit respective independent pseudo-random signals, the vibration detector detecting vibrations which (i) are emitted from the respective plurality of vibration emitters and (ii) are transmitted to the pen via the holder and the writing medium while the tip of the pen is in contact with the writing medium, a start pulse signal for the plurality of vibration emitters being in synchronization with a start pulse signal for the vibration detector, and said pen tablet device (i) carrying out a calculation to find a correlation between each of signals based on the respective vibrations detected by the vibration detector and a corresponding one of the independent pseudo-random signals to thereby find a delay time for a corresponding one of the plurality of vibration emitters and (ii) finding the coordinates of the tip of the pen from the delay time.

As described above, the pen tablet system of the present invention includes the pen tablet device; and a processing device for processing information indicative of coordinates of the tip of the pen, the pen of the pen tablet device including a transmitting section for transmitting the information indicative of the coordinates of the tip of the pen, and the processing device including a receiving section for receiving the information indicative of the coordinates of the tip of the pen which information is transmitted from the transmitting section.

It is therefore possible to provide (i) a pen tablet device capable of recording handwriting while converting the handwriting into electronic data even in a case where a regular sheet of paper or a notebook on which no pattern or the like is printed is used and (ii) a pen tablet system including the pen tablet device.

### BRIEF DESCRIPTION OF DRAWINGS

FIG. 1 is a view schematically illustrating a configuration of a pen tablet system in accordance with one embodiment of the present invention.

FIG. 2 is a plan view illustrating an ultrasonic transmission sheet of the pen tablet system in accordance with the one embodiment of the present invention illustrated in FIG. 1.

FIG. 3 is a view illustrating an example of a first shift register provided in a pseudo-random signal generating circuit of the pen tablet system in accordance with the one embodiment of the present invention.

FIG. 4 is a view illustrating an example of a second shift register provided in the pseudo-random signal generating circuit of the pen tablet system in accordance with the one embodiment of the present invention.

FIG. 5 is a view schematically illustrating a configuration of the pseudo-random signal generating circuit which generates a pseudo-random signal, in the pen tablet system in accordance with the one embodiment of the present invention.

FIG. 6 is a view illustrating (i) the ultrasonic transmission sheet which has ultrasonic emitters and (ii) pseudo-random signal generating circuits for applying respective independent pseudo-random signals (Gold sequences) to the ultrasonic emitters.

(a) of FIG. 7 is a view showing a cross-correlation between a PRN1-sequence pseudo-random signal and each of PRN1 to PRN4-sequence pseudo-random signals. (b) of FIG. 7 is a view showing a cross-correlation between the PRN2-sequence pseudo-random signal and each of the PRN1 to PRN4-sequence pseudo-random signals. (c) of FIG. 7 is a view showing a cross-correlation between the PRN3-sequence pseudo-random signal and each of the PRN1 to PRN4-sequences pseudo-random signals. (d) of FIG. 7 is a view showing a cross-correlation between the PRN4-sequence pseudo-random signal and each of the PRN1 to PRN4-sequence pseudo-random signals.

(a) of FIG. 8 is a view illustrating a path through which an ultrasonic wave travels while a tip of a pen is in contact with a writing medium (i.e., when writing is carried out) in the pen tablet system in accordance with the one embodiment of the present invention. (b) of FIG. 8 is a view illustrating a path through which an ultrasonic wave travels when the tip of the pen is not in contact with the writing medium (i.e., when writing is not carried out) in the pen tablet system in accordance with the one embodiment of the present invention.

FIG. 9 is a view schematically illustrating a configuration of a part of a coordinate detection circuit provided in the pen in the pen tablet system in accordance with the one embodiment of the present invention.

FIG. 10 is a plan view illustrating the ultrasonic transmission sheet of the pen tablet system in accordance with the one embodiment of the present invention.

FIG. 11 is a view for explaining a method for calculating a correlation between (i) a signal U(t) obtained in the ultrasonic detector in the pen and (ii) a corresponding Gold sequence mi(t) to thereby find a time Ti (i=1 to 4) at which a correlation value reaches a peak, in the pen tablet system in accordance with the one embodiment of the present invention.

FIG. 12 is a view illustrating (i) a part of the coordinate detection circuit of the pen which part is for finding coordinates of the tip of the pen from times Ti at which correlation values reach their peak, (ii) a coordinate storage section, and (iii) a transmitting section, each of which is provided in the pen of the pen tablet system in accordance with the one embodiment of the present invention.

FIG. 13 is a view illustrating an example of a pen tablet system including a pen that includes an output circuit instead of the transmitting section.

FIG. 14 is a view showing an example of (i) data of the coordinates of the tip of the pen and (ii) data of valid detection flags which indicate validity of detection, each of which is stored in the coordinate storage section provided in the pen, in the pen tablet system in accordance with the one embodiment of the present invention.

FIG. 15 is a view showing compressed information (compressed data) indicative of movement (gesture) of the pen, which information is generated by a data compression section of a pen tablet system of another embodiment of the present invention. The compressed information (compressed data) is obtained from (i) data of coordinates for each frame and (ii) data, for each frame, of a valid detection flag which indicates validity of detection ((i) and (ii) are shown in FIG. 14).

FIG. 16 is an external view of the pen for use in the pen tablet system in accordance with the another embodiment of the present invention.

FIG. 17 is a view showing a case where a new page number is added after a gesture event in the compressed data shown in FIG. 14.

FIG. 18 is a view showing a flow chart of a main program of a CPU provided in the pen of the pen tablet system in accordance with the another embodiment of the present invention.

FIG. 19 is a view schematically illustrating a configuration of an ultrasonic transmission sheet and a pen of a pen tablet system in accordance with a further embodiment of the present invention.

FIG. 20 is a view schematically illustrating a configuration of a part of a coordinate detection circuit provided in the pen of the pen tablet system in accordance with the further embodiment of the present invention.

FIG. 21 is a plan view illustrating the ultrasonic transmission sheet of the pen tablet system in accordance with the further embodiment of the present invention.

FIG. 22 is a view schematically illustrating a configuration of a conventional pen tablet device described in Patent Literature 1.

### DESCRIPTION OF EMBODIMENTS

Embodiments of the present invention will be described below in detail with reference to the drawings. Note, however, that the dimensions, materials, shapes, relative locations, and the like of respective constituent elements described in Embodiments are illustrative only, and that the scope of the present invention should not be narrowly construed based on them.

### Embodiment 1

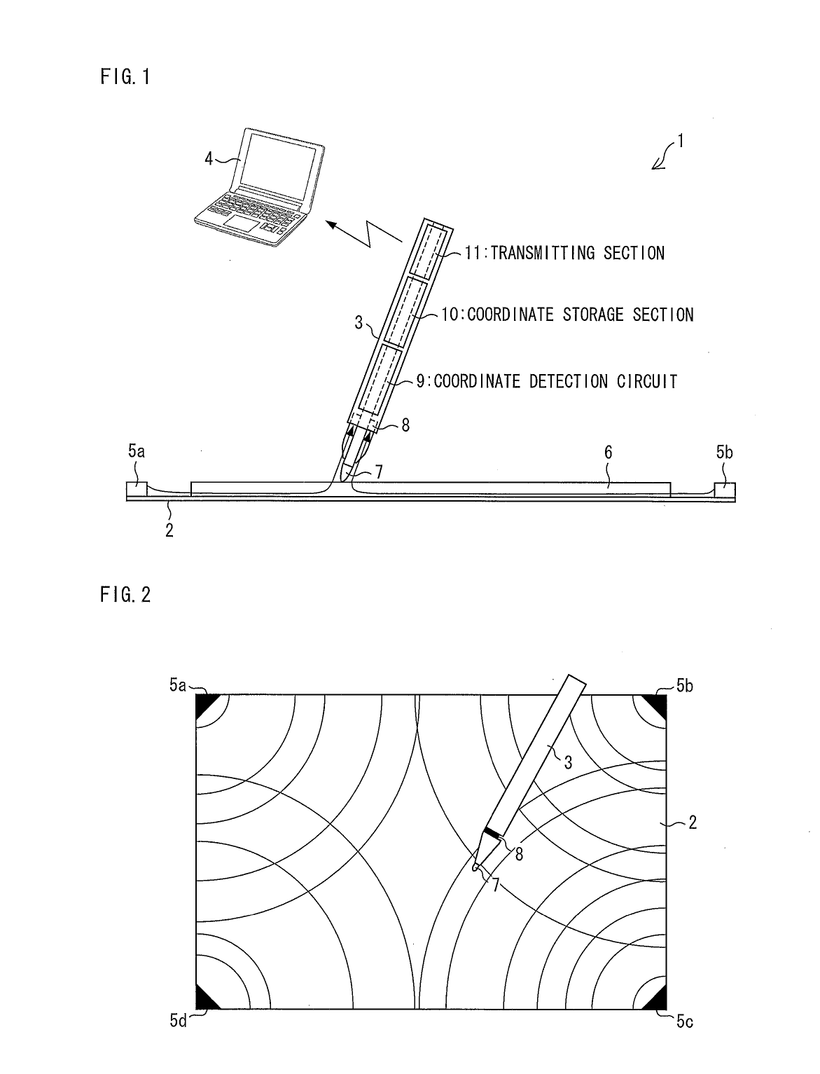

FIG. 1 is a view schematically illustrating a configuration of a pen tablet system 1.

As illustrated in FIG. 1, the pen tablet system 1 includes an ultrasonic transmission sheet 2 (holder) which transmits ultrasonic waves, a pen 3, and a host computer 4 (processing device).

The ultrasonic transmission sheet 2 has, at its four corners, respective four ultrasonic emitters 5a, 5b, 5c and 5d. The four ultrasonic emitters 5a, 5b, 5c and 5d are arranged to operate in response to respective four independent pseudo-random signals, which are generated by respective four pseudo-random signal generating circuits (C/A code generators, described later in detail).

On the ultrasonic transmission sheet 2, there is placed a writing medium 6 such as a sheet of paper or a notebook.

The pen 3 includes, at its tip, a writing instrument 7 such as a pencil lead or a ballpoint pen ink core. The writing instrument is a tip member which makes contact with the writing medium 6 and thereby transmits vibration. While the writing instrument 7 is in contact with the writing medium 6, handwriting is recorded on the writing medium 6.

The pen 3 further includes an ultrasonic detector 8 for detecting ultrasonic waves emitted from the four ultrasonic emitters 5a, 5b, 5c and 5d. The ultrasonic detector 8 is provided at a predetermined distance from the writing instrument 7.

As illustrated in FIG. 1, the ultrasonic waves emitted from the four ultrasonic emitters 5a, 5b, 5c and 5d (i) are transmitted to the pen 3 via the ultrasonic transmission sheet 2 and the writing medium 6 while the tip of the pen 3 is in contact with the writing medium 6 and (ii) are detected by the ultrasonic detector 8 (vibration detector) included in the pen 3.

The pen 3 further includes (i) a coordinate detection circuit 9 for obtaining absolute coordinates of the tip of the pen 3 by detecting ultrasonic waves, (ii) a coordinate storage section 10 (memory) for storing information of a set of the coordinates thus obtained, and (iii) a transmitting section 11 for transmitting, to a receiving section (not illustrated) provided in the host computer 4, the information of the set of the coordinates thus obtained.

FIG. 2 is a plan view of the ultrasonic transmission sheet 2 of the pen tablet system 1 illustrated in FIG. 1.

As illustrated in FIG. 2, the four ultrasonic emitters 5a, 5b, 5c, and 5d are provided in the respective four corners of the ultrasonic transmission sheet 2. That is, the four ultrasonic emitters 5a, 5b, 5c, and 5d are provided in respective positions in each of which edges of the ultrasonic transmission sheet 2 intersect each other.

The four ultrasonic emitters 5a, 5b, 5c, and 5d are configured to operate in response to the four independent pseudo-random signals which are generated by the respective four pseudo-random signal generating circuits (not illustrated, described later in detail).

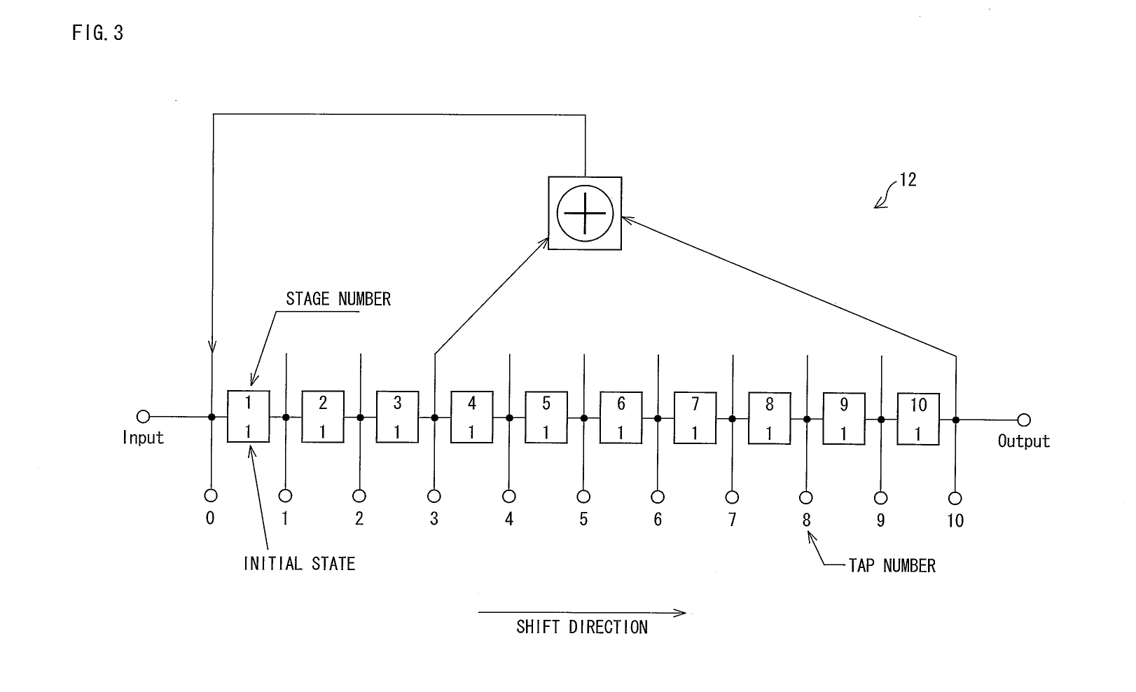

The following schematically describes, with reference to FIGS. 3 through 7, a configuration of a pseudo-random signal generating circuit.

First, the following description will discuss (i) how an M-sequence, which is a type of a pseudo-random number sequence, is generated and (ii) characteristics of the M-sequence.

The pseudo-random sequence is a sequence that appears to be a random sequence which has equiprobability and randomness but is actually obtained by calculation. Since the pseudo-random sequence is generated by calculation, the pseudo-random sequence has a reproducible periodicity and is theoretically predictable provided that how to generate it is known, unlike a random sequence that is not reproducible,

The M-sequence is an abbreviation for a Maximum-length linearly recurring sequence.

The M-sequence can be generated by using a shift register and an exclusive OR function.

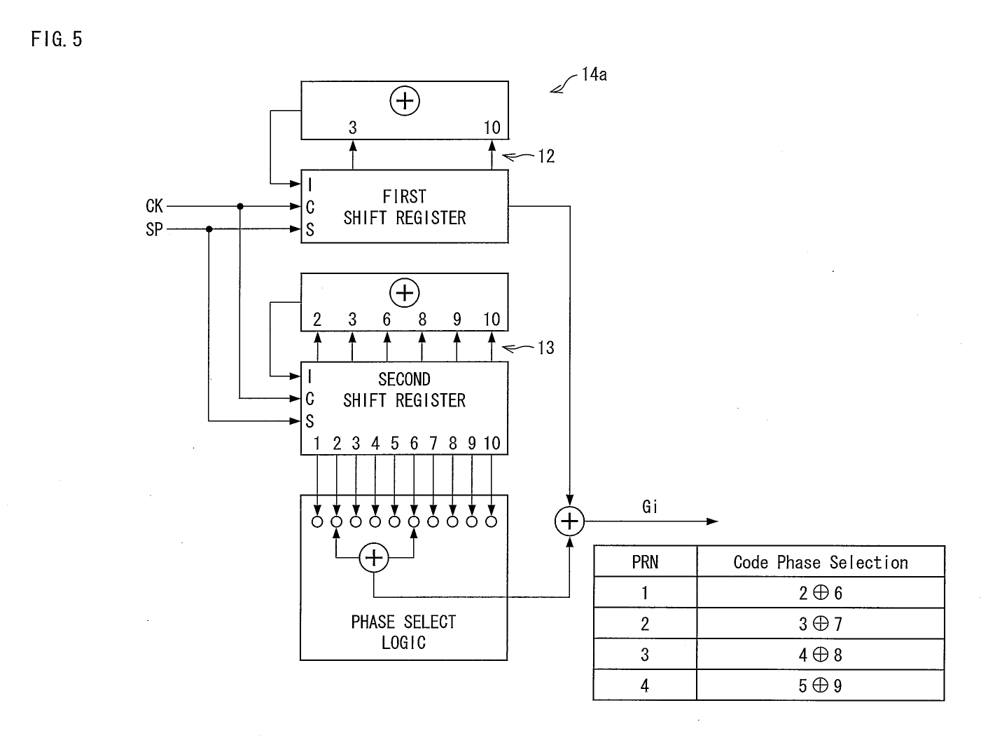

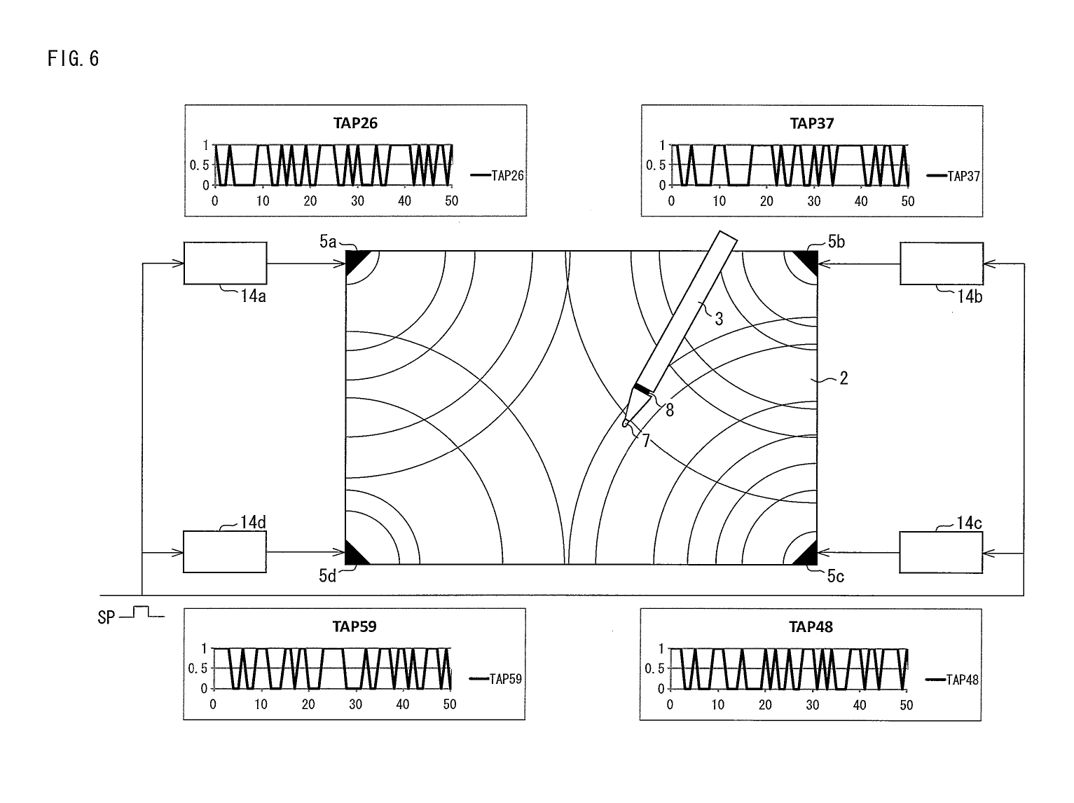

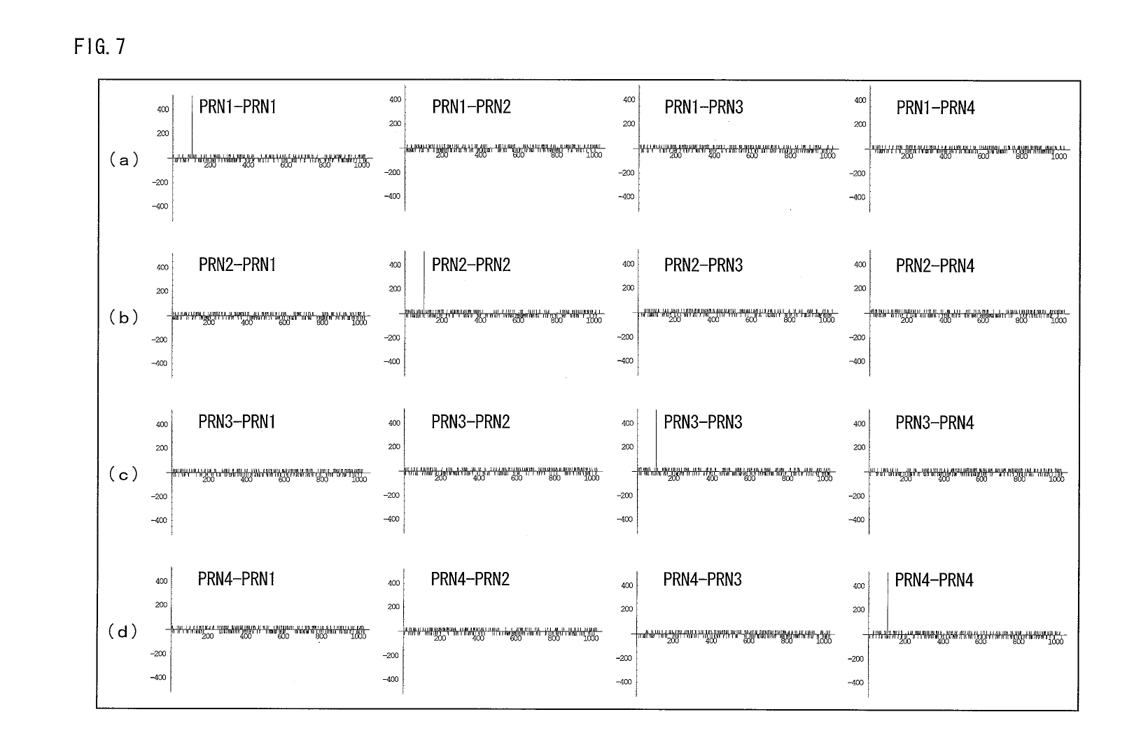

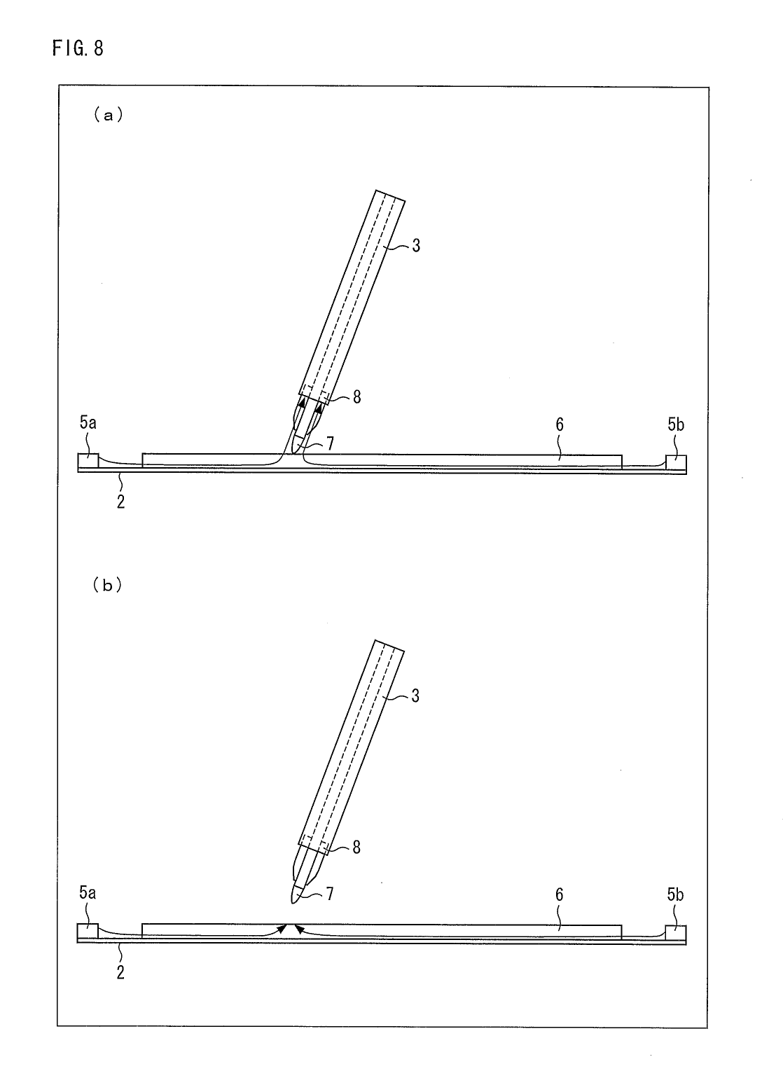

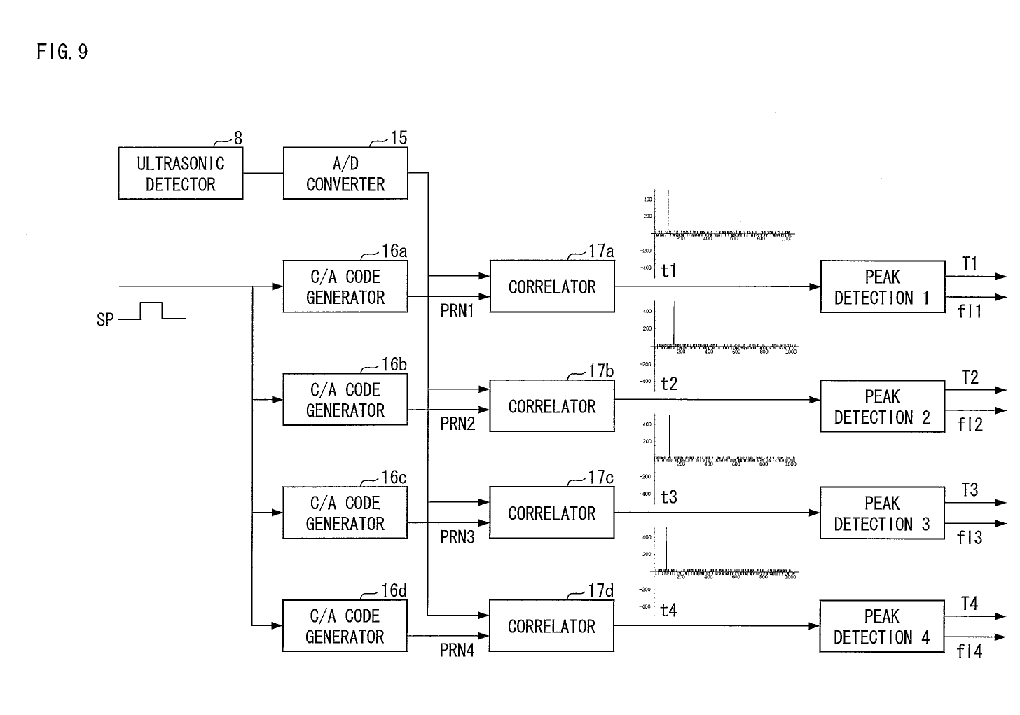

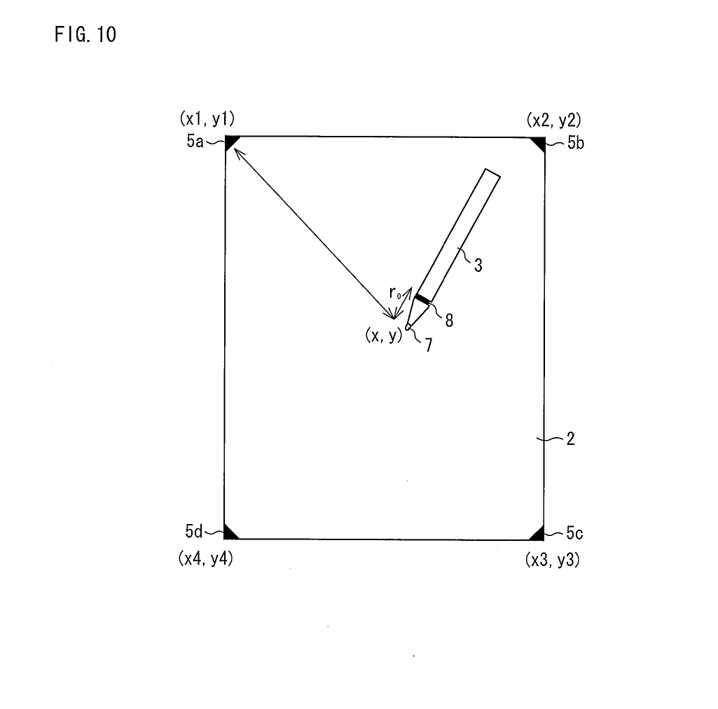

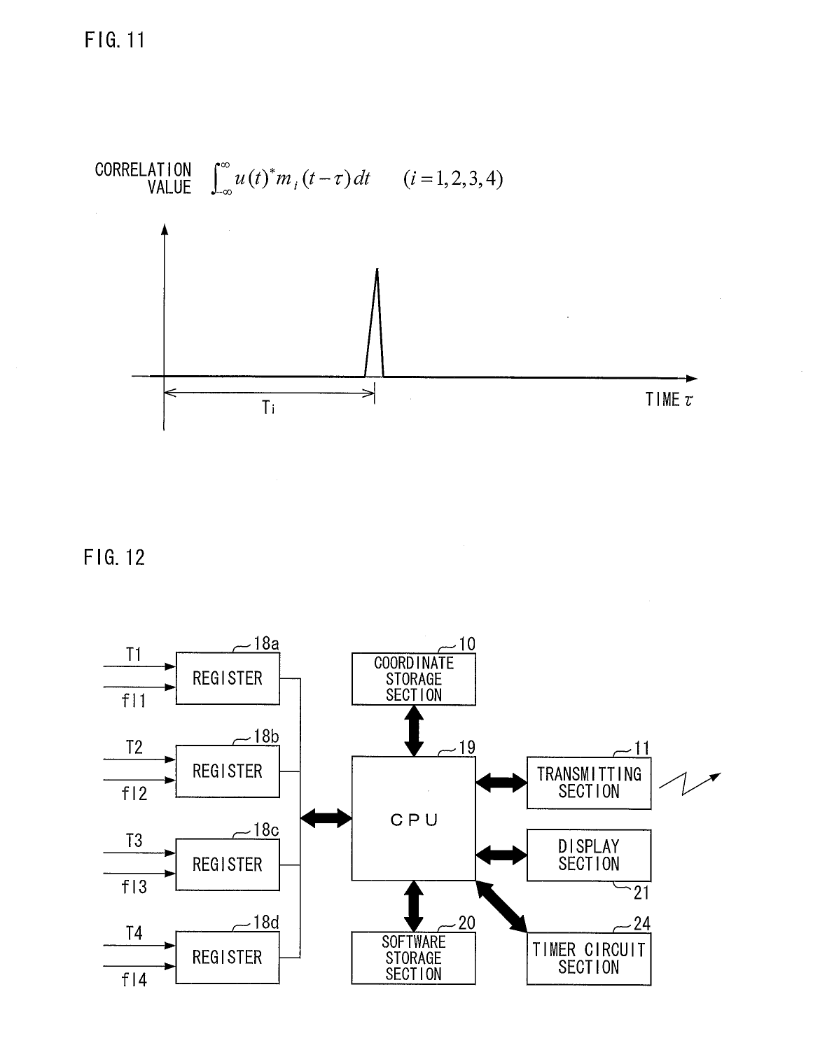

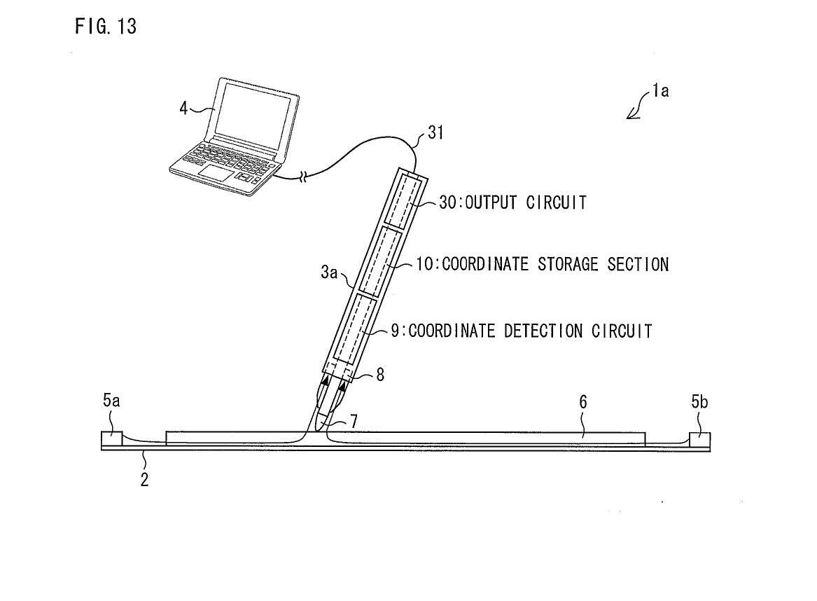

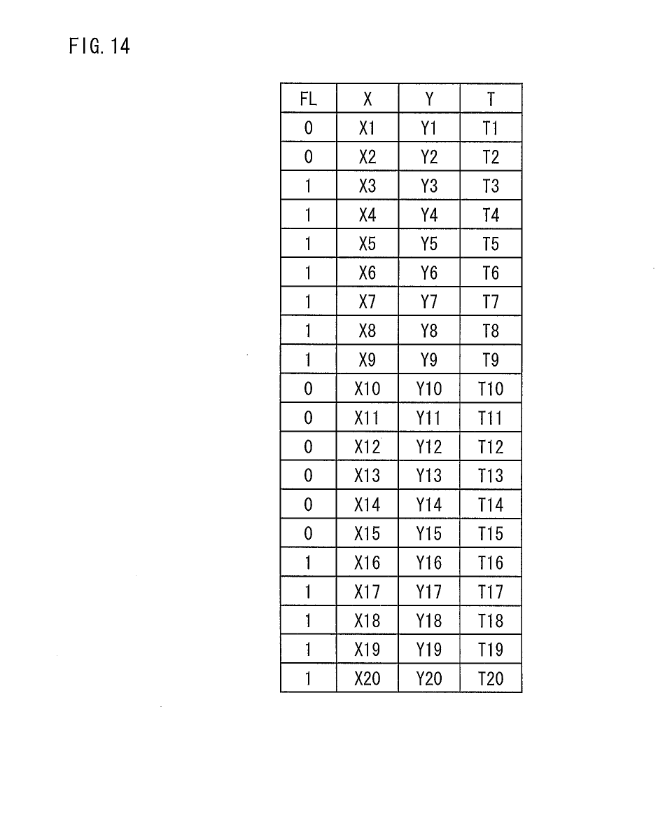

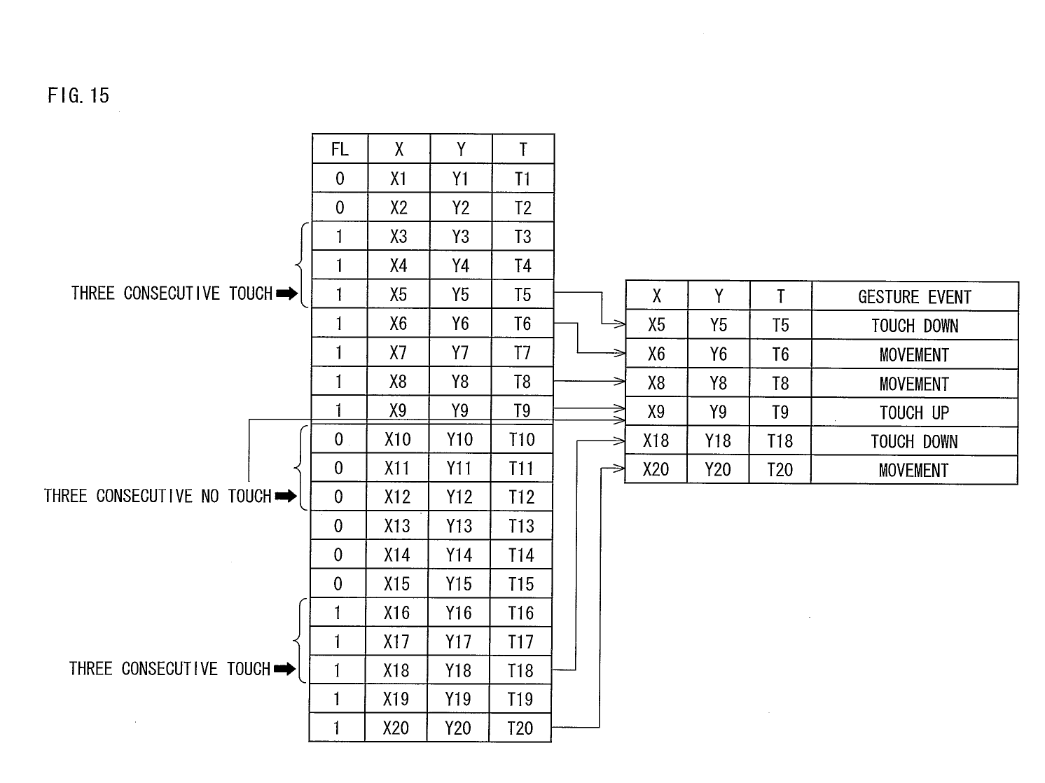

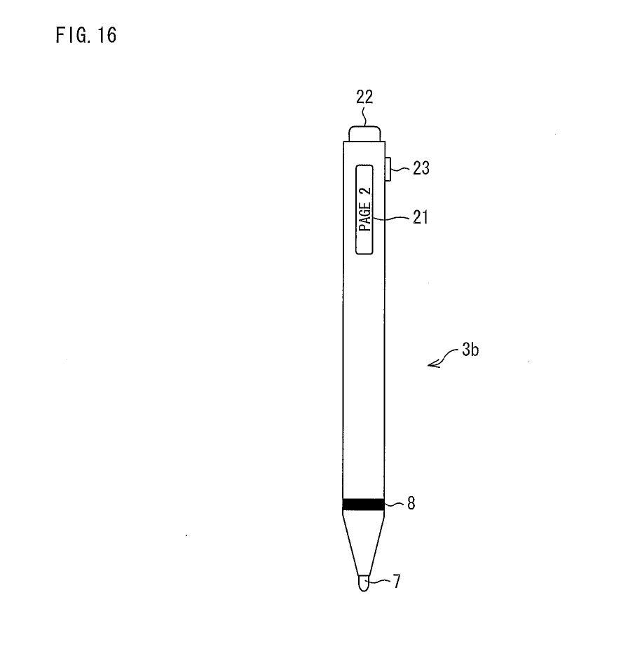

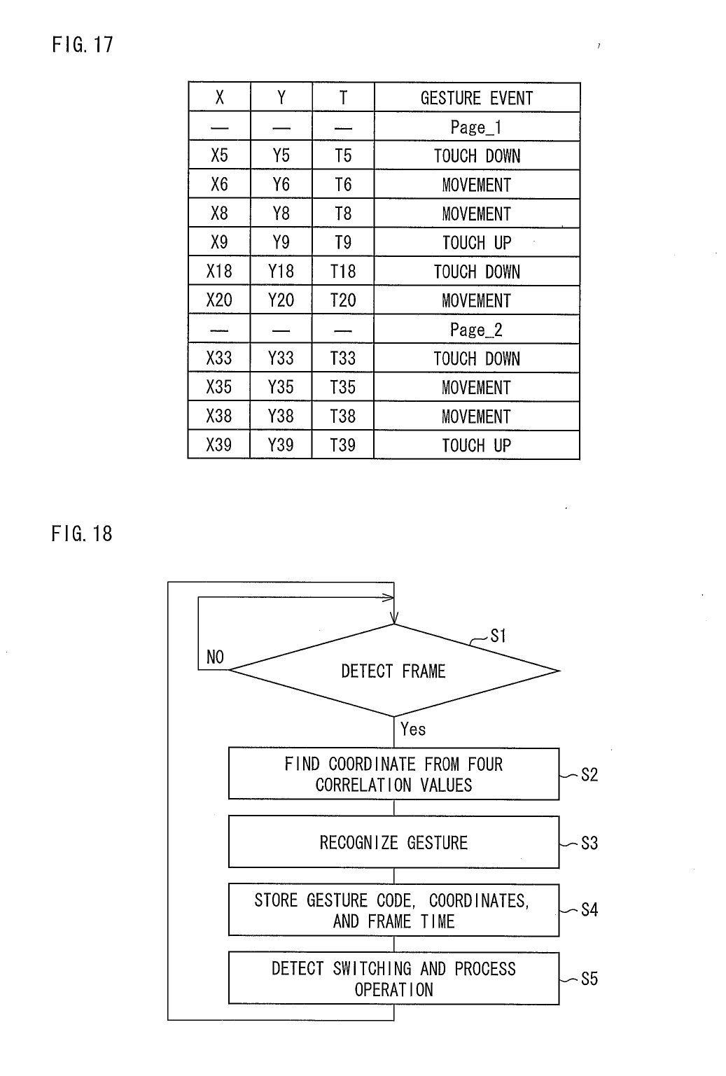

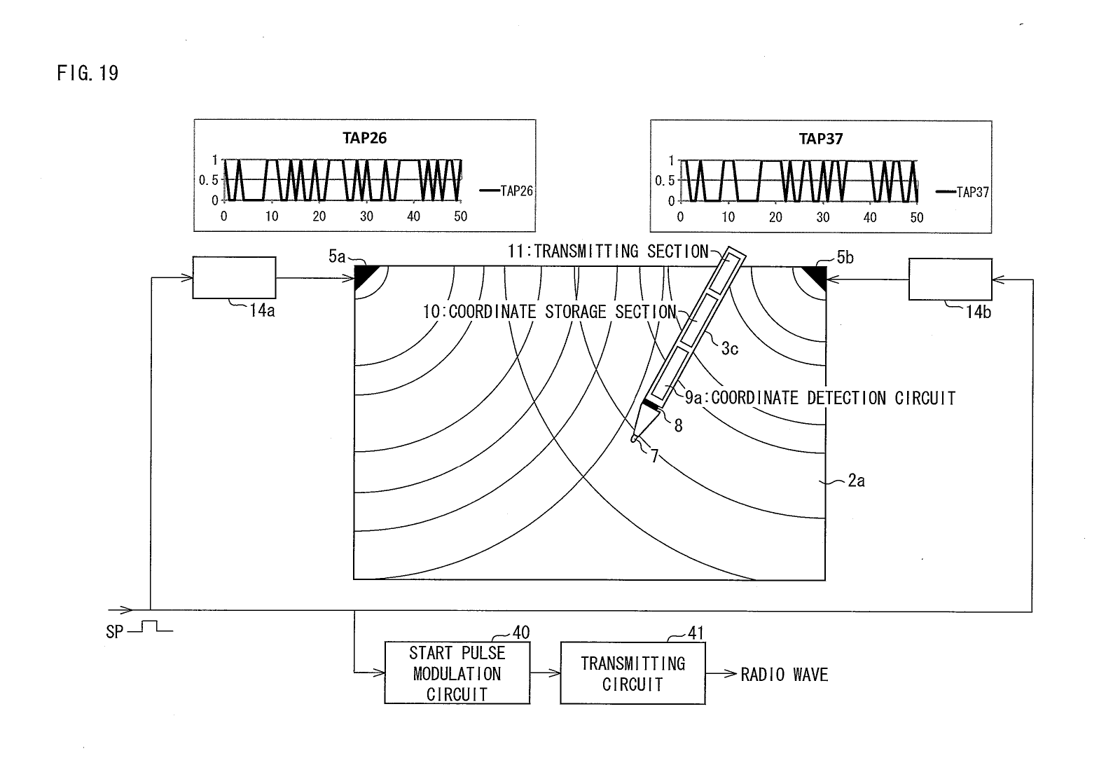

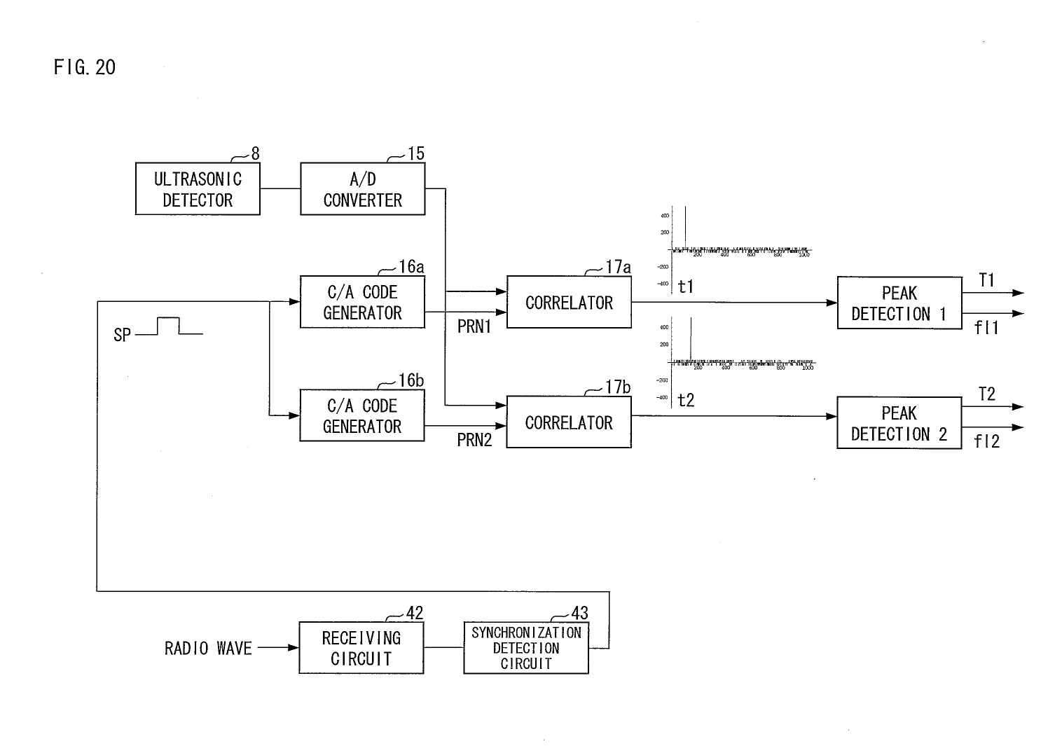

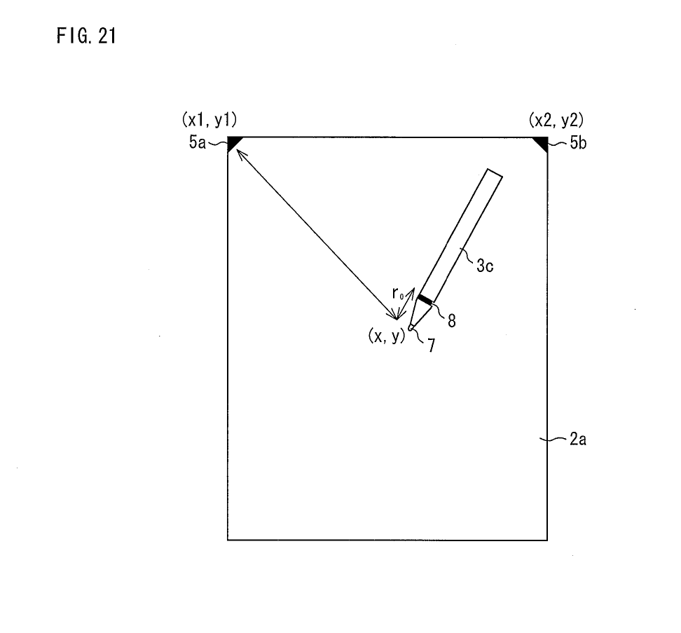

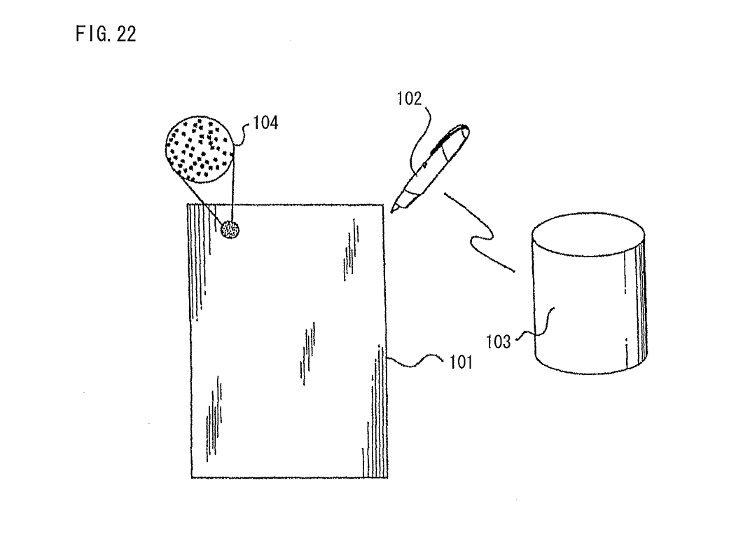

FIG. 3 is a view illustrating an example of a first shift register 12 provided in each of pseudo-random signal generating circuits 14a, 14b, 14c, and 14d illustrated in FIGS. 5 and 6.

As illustrated in FIG. 3, in the 10-stage (10-bit) first shift register 12, an XOR (exclusive OR) of Q outputs from the third and tenth flip-flops of the first shift register 12 is fed back to an input of the first shift register 12. This generates an M-sequence having a frequency of 2¹⁰−1 bits.

The first shift register 12 is configured such that a stage is shifted to the right, which is a shift direction illustrated in FIG. 3, at every rising of a CK signal

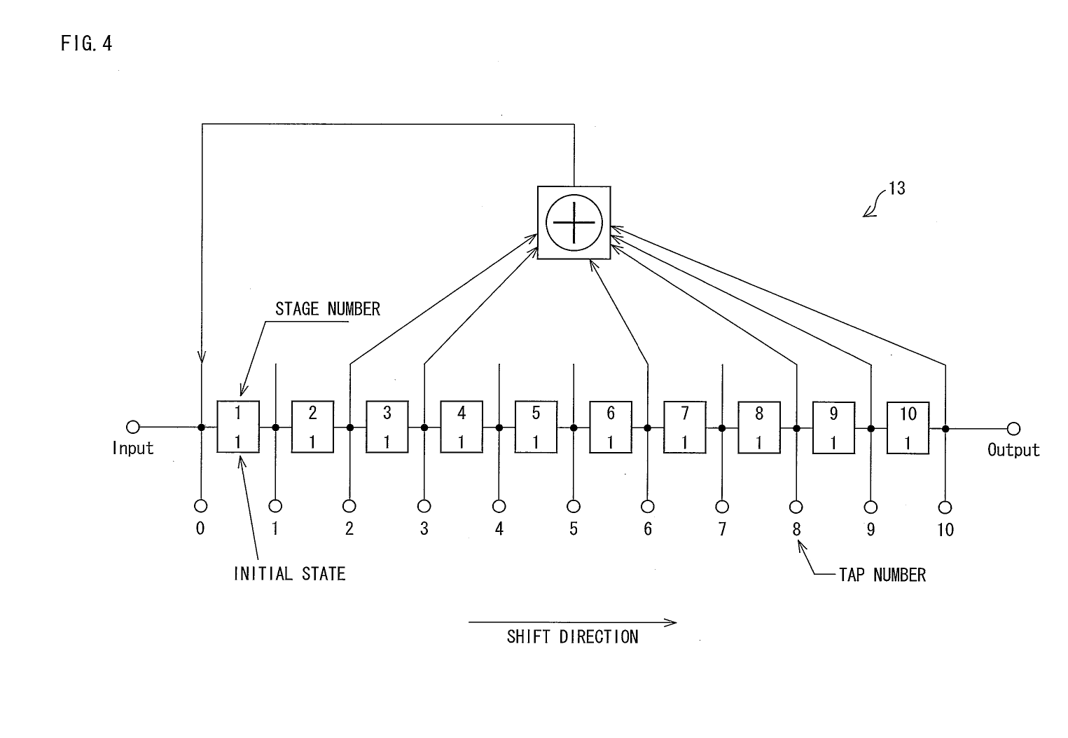

FIG. 4 is a view illustrating an example of a second shift register 13 provided in each of the pseudo-random signal generating circuits 14a, 14b, 14c, and 14d illustrated in FIGS. 5 and 6.

As illustrated in FIG. 4, in the 10-stage (10-bit) second shift register 13, an XOR (exclusive OR) of Q outputs from all the second, third, sixth, eighth, ninth, and tenth flip-flops of the second shift register 13 is fed back to an input of the second shift register 13. This generates an M-sequence having a frequency of 2¹⁰−1 bits.

The second shift register 13 is configured such that a stage is shifted to the right, which is a shift direction illustrated in FIG. 4, at every rising of the CK signal.

FIG. 5 is a view illustrating the pseudo-random signal generating circuit 14a which generates a pseudo-random signal.

As illustrated in FIG. 5, the pseudo-random signal generating circuit 14a includes the first shift register 12 (illustrated in FIG. 3) and the second shift register 13 (illustrated in FIG. 4) which is provided with a selector which selects Q outputs from two of the ten flip-flops. The pseudo-random signal generating circuit 14a is configured such that an XOR (exclusive OR) of (i) the Q outputs from the two flip-flops selected by the selector and (ii) an output from the last stage of the first shift register 12 is supplied to a Gi terminal.

By changing how to select two Q output terminals (TAP numbers) by the selector, it is possible to obtain a different Gold sequence (PRN sequence).

In the pseudo-random signal generating circuit 14a in FIG. 5, the second Q output terminal (TAP number) and the sixth Q output terminal (TAP number) are selected. In this case, an obtained pseudo-random signal is a PRN1 sequence signal.

In a case where the third Q output terminal (TAP number) and the seventh Q output terminal (TAP number) are selected, an obtained pseudo-random signal is a PRN2-sequence signal. In a case where the fourth Q output terminal (TAP number) and the eighth Q output terminal (TAP number) are selected, an obtained pseudo-random signal is a PRN3-sequence signal. In a case where the fifth Q output terminal (TAP number) and the ninth Q output terminal (TAP number) are selected, an obtained pseudo-random signal is a PRN4-sequence signal. Note that these are not illustrated.

In the manner described above, it is possible, by use of the pseudo-random signal generating circuit defined by the GPS (Global Positioning System) standard, to obtain independent pseudo-random signals (Gold sequences) having a 2¹⁰−1=1023 clock period.

FIG. 6 is a view illustrating (i) the ultrasonic transmission sheet 2 which has the ultrasonic emitters 5a, 5b, 5c, and 5d at its four corners and (ii) the four pseudo-random signal generating circuits 14a, 14b, 14c, and 14d for applying, to the ultrasonic emitters 5a, 5b, 5c, and 5d, respective independent pseudo-random signals (Gold sequences).

As illustrated in FIG. 6, the ultrasonic emitter 5a at the upper left corner of the ultrasonic transmission sheet 2 receives the PRN1-sequence pseudo-random signal obtained in the pseudo-random signal generating circuit 14a (illustrated in FIG. 5), in which the second Q output terminal (TAP number) and the sixth Q output terminal (TAP number) are selected.

The ultrasonic emitter 5b at the upper right corner of the ultrasonic transmission sheet 2 receives the PRN2-sequence pseudo-random signal obtained in the pseudo-random signal generating circuit 14b, in which the third Q output terminal (TAP number) and the seventh Q output terminal (TAP number) are selected.

The ultrasonic emitter 5c at the lower right corner of the ultrasonic transmission sheet 2 receives the PRN3-sequence pseudo-random signal obtained in the pseudo-random signal generating circuit 14c, in which the fourth Q output terminal (TAP number) and the eighth Q output terminal (TAP number) are selected.

The ultrasonic emitter 5d at the lower left corner of the ultrasonic transmission sheet 2 receives the PRN4-sequence pseudo-random signal obtained in the pseudo-random signal generating circuit 14d, in which the fifth Q output terminal (TAP number) and the ninth Q output terminal (TAP number) are selected.

That is, the respective ultrasonic emitters 5a, 5b, 5c, and 5d are arranged to emit ultrasonic waves which are respective independent pseudo-random signals.

FIG. 7 is a view showing cross-correlations among the PRN1, PRN2, PRN3 and PRN4-sequence pseudo-random signals, which are obtained in the pseudo-random signal generating circuits 14a, 14b, 14c, and 14d, respectively.

(a) of FIG. 7 shows a cross-correlation between the PRN1-sequence pseudo-random signal and each of the PRN1 to PRN4-sequence pseudo-random signals. As is clear from (a) of FIG. 7, the PRN1-sequence pseudo-random signal is sufficiently independent of pseudo-random signals other than the PRN1-sequence pseudo-random signal. That is, the PRN1-sequence pseudo-random signal is sufficiently independent of the PRN2 to PRN4-sequence pseudo-random signals.

(b) of FIG. 7 shows a cross-correlation between the PRN2-sequence pseudo-random signal and each of the PRN1 to PRN4-sequence pseudo-random signals. As is clear from (b) of FIG. 7, the PRN2-sequence pseudo-random signal is sufficiently independent of pseudo-random signals other than the PRN2-sequence pseudo-random signal. That is, the PRN2-sequence pseudo-random signal is sufficiently independent of the PRN1, PRN3, and PRN4-sequence pseudo-random signals.

(c) of FIG. 7 shows a cross-correlation between the PRN3-sequence pseudo-random signal and each of the PRN1 to PRN4-sequence pseudo-random signals. As is clear from (c) of FIG. 7, the PRN3-sequence pseudo-random signal is sufficiently independent of pseudo-random signals other than the PRN3-sequence pseudo-random signal. That is, the PRN3-sequence pseudo-random signal is sufficiently independent of the PRN1, PRN2, and PRN4-sequence pseudo-random signals.

(d) of FIG. 7 shows a cross-correlation between the PRN4-sequence pseudo-random signal and each of the PRN1 to PRN4-sequence pseudo-random signals. As is clear from (d) of FIG. 7, the PRN4-sequence pseudo-random signal is sufficiently independent of pseudo-random signals other than the PRN4-sequence pseudo-random signal. That is, the PRN4-sequence pseudo-random signal is sufficiently independent of the PRN1 to PRN3-sequence pseudo-random signals.

As is clear from the description above, each of the PRN1 to PRN4-sequence pseudo-random signals has an excellent autocorrelation property and is sufficiently independent of pseudo-random signals of other sequences.

FIG. 8 is a view illustrating a difference between paths through which ultrasonic waves travel when the tip of the pen 3 is in contact with the writing medium 6 (when writing is carried out) and when the tip of the pen 3 is not in contact with the writing medium 6 (when writing is not carried out).

(a) of FIG. 8 shows a path through which an ultrasonic wave travels while writing is carried out, with the use of the pen 3, on the writing medium 6 (e.g., a notebook or a sheet of writing paper) placed on the ultrasonic transmission sheet 2.

First, ultrasonic waves generated from the respective ultrasonic transducers 5a, 5b, 5c, and 5d provided at the respective four corners of the ultrasonic transmission sheet 2 propagate through the ultrasonic transmission sheet 2.

There is the writing medium 6 (e.g., a notebook or a sheet of writing paper) placed on the ultrasonic transmission sheet 2. While writing is carried out with the use of the pen 3, the tip of the pen 3, at which tip the writing instrument 7 (e.g., a pencil lead or a ballpoint pen ink core) is provided, is pressed against the writing medium 6. Therefore, vibration of the ultrasonic transmission sheet 2 is transmitted to the pen 3 via the writing medium 6 and the writing instrument 7. This allows the ultrasonic detector 8 provided in the pen 3 to detect a sufficient level of ultrasonic waves which are generated from the ultrasonic transducers 5a, 5b, 5c, and 5d.

On the other hand, (b) of FIG. 8 shows a path through which an ultrasonic wave travels while writing is not carried out with the use of the pen 3.

While writing is not carried out with the use of the pen 3, the tip of the pen 3, at which tip the writing instrument 7 (e.g., a pencil lead or a ballpoint pen core) is provided, is not pressed against the writing medium 6. Therefore, vibration of the ultrasonic transmission sheet 2 considerably decreases before reaching the writing instrument 7 at the tip of the pen 3. As a result, the ultrasonic detector 8 provided in the pen 3 detects little of the ultrasonic waves generated from the ultrasonic transducers 5a, 5b, 5c, and 5d.

FIG. 9 is a view schematically illustrating a configuration of a part of a coordinate detection circuit 9 provided in the pen 3. In this part, a cross-correlation between (i) a signal obtained in the ultrasonic detector 8 provided in the pen 3 and (ii) a corresponding one of the PRN1 to PRN4-sequence pseudo-random signal described above is obtained, and a time Ti (i=1 to 4) at which a correlation value reaches a peak is obtained.

As illustrated in FIG. 9, an ultrasonic wave detected by the ultrasonic detector 8 is converted into an electric signal and then is inputted to an A/D converter 15. The A/D converter 15 is connected to input terminals of respective four correlators 17a, 17b, 17c, and 17d. Furthermore, outputs of respective four C/A code generators 16a, 16b, 16c, and 16d are connected to the respective input terminals of the four correlators 17a, 17b, 17c, and 17d.

The C/A code generator 16a has the same configuration as that of the pseudo-random signal generating circuit 14a in which the second Q output terminal (TAP number) and the sixth Q output terminal (TAP number) are selected (see FIG. 5). A PRN1-sequence pseudo-random signal outputted from the C/A code generator 16a is applied to the correlator 17a.

The C/A code generator 16b has the same configuration as that of the pseudo-random signal generating circuit 14b in which the third Q output terminal (TAP number) and the seventh Q output terminal (TAP number) are selected. A PRN2-sequence pseudo-random signal outputted from the C/A code generator 16b is applied to the correlator 17b.

The C/A code generator 16c has the same configuration as that of the pseudo-random signal generating circuit 14c in which the fourth Q output terminal (TAP number) and the eighth Q output terminal (TAP number) are selected. A PRN3-sequence pseudo-random signal outputted from the C/A code generator 16c is applied to the correlator 17c.

The C/A code generator 16d has the same configuration as that of the pseudo-random signal generating circuit 14d in which the fifth Q output terminal (TAP number) and the ninth Q output terminal (TAP number) are selected. A PRN4-sequence pseudo-random signal outputted from the C/A code generator 16d is applied to the correlator 17d.

In each of the correlators 17a, 17b, 17c, and 17d, the time Ti (i=1 to 4), which is the time from when a start pulse signal SP is generated to when a correlation value reaches a peak in the each of the correlators 17a, 17b, 17c, and 17d, is measured.

The correlators 17a, 17b, 17c, and 17d are configured to output valid detection flags f11 through f14 indicative of validity of detection when the peak correlation value exceeds a certain threshold.

The following description will discuss (i) how to calculate the time Ti (i=1 to 4) at which a correlation value reaches a peak and (ii) how to detect coordinates.

Assuming that a pseudo-random function outputted from each of the ultrasonic emitters 5a, 5b, 5c, and 5d is m(t), a corresponding ultrasonic vibration U(t) detected by the ultrasonic detector 8 can be represented by the following equation (1):

$$\begin{matrix}[ Math . 1 ] & \\ U ( t ) = m ( t - \frac{\sqrt{{( {x}_{i} - x )}^{2} + {( {y}_{i} - y )}^{2}} + {r}_{0} + {a}_{0}}{c} ) & Equation ( 1 )\end{matrix}$$

Furthermore, a correlation between the equation (1) and the m(t) can be represented by the following equation (2):

$$\begin{matrix} [ Math . 2 ] & \\ {\int }_{- ∞}^{∞} {U ( t )}^{*} m ( t - τ ) d t = {\int }_{- ∞}^{∞} m ( t - \frac{\sqrt{{( {x}_{i} - x )}^{2} + {( {y}_{i} - y )}^{2}} + {r}_{0} + {a}_{0}}{c} ) {}^{*} m ( t - τ ) d t & Equation ( 2 )\end{matrix}$$

As shown in the following equation (3), an autocorrelation function of m(t) is a Dirac function δ(τ). Therefore, a correlation between (i) the ultrasonic vibration U(t) detected by the ultrasonic detector 8 and (ii) an M-sequence is given by the following equation (4):

$$\begin{matrix} [ Math . 3 ] & \\ {\int }_{- ∞}^{∞} {m ( t )}^{*} m ( t - τ ) d t = δ ( τ ) & Equation ( 3 ) \\ [ Math . 4 ] & \\ {\int }_{- ∞}^{∞} {U ( t )}^{*} m ( t - τ ) d t = δ ( τ - \frac{\sqrt{{( {x}_{i} - x )}^{2} + {( {y}_{i} - y )}^{2}} + {r}_{0} + {a}_{0}}{c} ) & Equation ( 4 )\end{matrix}$$

In the equations (1), (2), and (4): (xi, yi) are coordinates, on the ultrasonic transmission sheet 2, of the i-th ultrasonic emitter; r₀ is a distance from the ultrasonic transmission sheet 2 to the ultrasonic detector 8; c is speed of an ultrasonic wave; and a₀ is a value obtained by multiplying “a time difference between (i) a start pulse signal which drives the ultrasonic emitter 5a, 5b, 5c, or 5d and (ii) a start pulse signal for a corresponding one of the correlators 17a, 17b, 17c, and 17d provided in the pen 3” by “the speed of the ultrasonic wave”.

FIG. 10 is a plan view of the ultrasonic transmission sheet 2. The coordinates of the ultrasonic emitters 5a, 5b, 5c, and 5d are (x1, y1), (x2, y2), (x3, y3), and (x4, y4), respectively.

In this arrangement, a correlation between (i) a signal U(t) obtained in the ultrasonic detector 8 in the pen 3 and (ii) a corresponding Gold sequence mi(t) is obtained, and the time Ti (i=1 to 4) at which a correlation value reaches a peak is obtained (see FIG. 11).

In this manner, the following four kinds of equation (5) are obtained, which define the time (delay time) Ti (i=1 to 4) at which a correlation value reaches a peak:

[Math. 5]

Tᵢ×c=\sqrt{(xᵢ−x)²+(yᵢ−y)²}+r₀+a₀ (i=1,2,3,4) Equation (5)

Since the equation (5) has three unknowns: x, y, and (r₀+a₀), the coordinates can be determined by the least squares method.

In a case where the writing instrument 7 provided at the tip of the pen 3 is a pencil lead or the like which changes in length when used, r₀ is an unknown. On the other hand, in a case where the writing instrument 7 is a ballpoint pen ink core or the like which does not change in length even when used, a predetermined value can be used as r₀.

In Embodiment 1, the writing instrument 7 is a ballpoint pen ink core or the like, which does not change in length even when used. However, since a₀ is still unknown, (r₀+a₀) is considered as one unknown r₀.

Next, in the equation (5), “Ti×c” is replaced with a pseudo-measured distance Ri. Then, Newton's method is used to find true coordinates through the four kinds of equation (5) (wherein i=1 to 4) by the least squares method.

The following description will specifically discuss a calculation by the Newton's method.

First, the “Ti×c” in the equation (5) is replaced with the pseudo-measured distance Ri, and a partial derivative of the equation (5) is calculated. In this way, the following equation (6) is obtained:

$$\begin{matrix}[ Math . 6 ] & \\ Δ {R}_{i} = \frac{δ {R}_{i}}{δ x} Δ x + \frac{δ {R}_{i}}{δ y} Δ y + Δ r & Equation ( 6 )\end{matrix}$$

Furthermore, the following equations (7) and (8) are obtained from the equation (5):

$$\begin{matrix}[ Math . 7 ] & \\ \frac{δ {R}_{i}}{δ x} = \frac{- ( {x}_{i} - x )}{\sqrt{{( {x}_{i} - x )}^{2} + {( {y}_{i} - y )}^{2}}} & Equation ( 7 ) \\ [ Math . 8 ] & \\ \frac{δ {R}_{i}}{δ y} = \frac{- ( {y}_{i} - y )}{\sqrt{{( {x}_{i} - x )}^{2} + {( {y}_{i} - y )}^{2}}} & Equation ( 8 )\end{matrix}$$

Assuming that the equations (7) and (8) are αi and βi, respectively, the following equation (9) is obtained. In the equation (9), εi are errors.

$$\begin{matrix}[ Math . 9 ] & \\ ( \begin{matrix}Δ {R}_{1} \\ Δ {R}_{2} \\ Δ {R}_{3} \\ Δ {R}_{4}\end{matrix} ) = ( \begin{matrix}α 1 & β 1 & 1 \\ α 2 & β 2 & 1 \\ α 3 & β 3 & 1 \\ α 4 & β 4 & 1\end{matrix} ) ( \begin{matrix}Δ x \\ Δ y \\ Δ r\end{matrix} ) + ( \begin{matrix}ɛ 1 \\ ɛ 2 \\ ɛ 3 \\ ɛ 4\end{matrix} ) & Equation ( 9 )\end{matrix}$$

The equation (9) can be represented by the following vector equation (10):

R=A·X+E Equation (10)

Assume that f is the sum of squared errors. When f is represented by the equation (10), the following equation (11) is obtained:

$$\begin{matrix}f = {E}^{T} \cdot E \\ = {( R \text{-} A \cdot X )}^{T} ( R \text{-} A \cdot X ) \\ = {R}^{T} R \text{-} 2 {R}^{T} AX + {X}^{T} ( {A}^{T} A ) X\end{matrix} \qquad Equation ( 11 )$$

It is only necessary to find X so that f is minimum.

Note that the superscript T indicates a transposed matrix.

The formula (II) is partially differentiated with respect to X and is replaced by 0, whereby the following equation (12) is obtained:

δf/δX=−2R^{T}·A+2XT(A^{T}A)=0 Equation (12)

Finally, the following equation (13) is obtained from the equation (12):

X=(A^{T}A)⁻¹A^{T}·R Equation (13)

where the superscript −1 indicates an inverse matrix.

The following description will discuss a calculation procedure carried out to find coordinates by the Newton's method.

First, coordinates (xi, yi) (i=1 to 4) of each of the four ultrasonic emitters 5a, 5b, 5c, and 5d and initial values (x0, y0, r₀) of (x, y, r) are substituted into the equations (7) and (8) to obtain αi and βi. This gives a matrix A.

Next, each of the four Ti values obtained from the correlation measurement is multiplied by c. This gives a vector R (Ri).

Then, from the matrix A and the vector R thus obtained, X is obtained through the equation (13).

Since the X is “Δx, Δy, and Δr” in the equation (9), the initial values (x0, y0, r₀) are replaced with (x0+Δx, y0+Δy, r₀+Δr). Then, the above-mentioned calculation procedure is repeated several times until the coordinates (x, y, r) converge. As a result, the coordinates (x, y, r) of the tip of the pen 3 are obtained.

FIG. 12 is a view illustrating (i) a part of the coordinate detection circuit 9, which part is for finding the coordinates of the tip of the pen 3 from the times Ti at which correlation values reach their peak, (ii) a coordinate storage section 10, and (iii) a transmitting section 11, each of which is provided in the pen 3.

Data of the times Ti (i=1 to 4) at which correlation values reach their peak and data of the valid detection flags f11 through f14 which indicate validity of detection, which are obtained in the part of the coordinate detection circuit 9 provided in the pen 3 (see FIG. 9), are stored in registers 18a, 18b, 18c, and 18d of an arithmetic processing circuit (see FIG. 12).

The registers 18a, 18b, 18c, and 18d are connected to a CPU 19 (processing section) via an I/O terminal, and the coordinate storage section 10 is connected to the CPU 19 via a bus.

The CPU 19 is connected also to the transmitting section 11 via an I/O terminal. In addition, the CPU 19 is connected to a software storage section 20 in which various kinds of software are stored (described later in detail).

The CPU 19 may be connected also to a display section 21 (described in Embodiment 2).

Furthermore, the CPU 19 is connected to a timer circuit section 24 which generates reference frames.

As illustrated in FIG. 12, when new values T1 through T4 are written in the registers 18a, 18b, 18c, and 18d and the detection flags f11 through f14 become valid, the CPU carries out the calculation procedure using the Newton's method to obtain, for each frame, the coordinates (x, y) of the tip of the pen 3.

As described above, the coordinates of the tip of the pen 3 obtained for each frame can be stored in the coordinate storage section 10. The data of the coordinates of the tip of the pen 3 obtained for each frame can be transmitted, when necessary, to the host computer 4 including the receiving section (see FIG. 1) via the transmitting section 11.

Note that Embodiment 1 deals with the pen 3 which includes the coordinate storage section 10 and the transmitting section 11. However, this does not imply any limitation. In a case where the pen 3 includes no coordinate storage section 10, the data of the coordinates of the tip of the pen 3 obtained for each frame may be transmitted, at regular intervals, to the host computer 4 via the transmitting section 11. On the other hand, in a case where the pen 3 includes no transmitting section 11, it is only necessary to provide a USB terminal or the like to the pen 3 and to connect the pen 3 to the host computer 4 via a cable so that the data of the coordinates of the tip of the pen 3 is read out to the host computer 4.

FIG. 13 is a view illustrating an example of a pen tablet system 1a including a pen 3a that includes an output circuit 30 instead of the transmitting section 11.

As illustrated in FIG. 13, the pen 3a includes the output circuit 30 instead of the transmitting section 11 illustrated in FIG. 1. A USB terminal provided to the pen 3a is connected to a cable 31, and the cable 31 is connected to a USB terminal of the host computer 4.

That is, the pen tablet system 1a illustrated in FIG. 13 is configured such that, for example, data of the coordinates of the tip of the pen 3a stored in the coordinate storage section 10 is transmitted from the output circuit 30 of the pen 3a to the host computer 4 via the cable 31.

FIG. 14 is a view showing an example of (i) data of the coordinates of the tip of the pen 3 and (ii) data of the valid detection flags which indicate validity of detection, each of which is stored in the coordinate storage section 10 (illustrated in FIG. 1).

Values in X and Y columns in FIG. 14 are x,y coordinates for respective frames. The x,y coordinates are calculated by the CPU 19 in accordance with coordinate reconstruction algorithm stored in the software storage section 20 (illustrated in FIG. 12).

Values in the FL column are the valid detection flags which indicate validity of detection. In a case where nothing is touching the writing medium and therefore no valid signal is detected by the ultrasonic detector 8, the flag is 0. On the other hand, in a case where the coordinates of the tip of the pen are successfully calculated, the flag is 1.

Further, values in the T column indicate frame times.

Note that, as illustrated in FIG. 2, Embodiment 1 deals with the ultrasonic transmission sheet 2 which has the four ultrasonic emitters 5a, 5b, 5c, and 5d in four positions in each of which edges of the ultrasonic transmission sheet 2 intersect each other. However, this does not imply any limitation. It is only necessary that three or more ultrasonic emitters be provided. Therefore, the number of the ultrasonic emitters can be determined as appropriate in consideration of a desired accuracy of coordinate detection and the like.

Furthermore, provided that the coordinates of the tip of the pen 3 can be detected, the number of the ultrasonic emitters may be two as described later in, for example, Embodiment 3.

As has been described, according to the pen tablet system 1, the coordinates of the tip of the pen 3 are detected with the use of independent ultrasonic signals which are modulated with the pseudo-random signals (Gold sequences). Accordingly, even in a case where ultrasonic signals are simultaneously generated from the respective four ultrasonic emitters 5a, 5b, 5c, and 5d, it is possible to simultaneously measure a distance from each of the four ultrasonic emitters 5a, 5b, 5c, and 5d to the tip of the pen 3.

Furthermore, the pen tablet system 1 is configured to detect whether or not the tip of the pen 3 touches the writing medium, by detecting an ultrasonic wave that starts being transmitted to the pen 3 when the tip of the pen 3 makes contact with the writing medium 6 (e.g., a notebook or a sheet of writing paper).

Therefore, according to the above configuration, it is unnecessary to provide an additional means for detecting whether or not the tip of the pen 3 touches the writing medium.

Furthermore, according to the above configuration, a distance from the tip of the pen 3 to the ultrasonic detector 8 provided in the pen 3 is the same in all the distances each of which is from the tip of the pen 3 to a corresponding ultrasonic emitter, and is included in the equation (5) as r₀. This makes it possible to calculate, with high accuracy, coordinates of a position where the tip of the pen 3 touches the writing medium even in a case where the writing instrument 7 provided at the tip of the pen 3 is a member (e.g., a pencil lead) which is worn out as being used.

Furthermore, according to the above configuration, the writing instrument 7 (e.g., a pencil lead or a ballpoint pen ink core) is provided at the tip of the pen 3. This makes it possible to (i) write letters and drawings on a paper notebook or the like as with conventional writing tools while (ii) converting the letters and the drawings into electronic image data that look the same as the original letters and the drawings on the paper notebook or the like.

This eliminates the need for scanning the letters or the drawings on the paper notebook or the like with an optical scanner. Therefore, it becomes very convenient particularly in a case where a patient's chart, a nurse's record, or the like which is still not fully converted into electronic form is used as the writing medium 6.

In Embodiment 1, the ultrasonic emitters are vibration emitters. Note, however, that this does not imply any limitation, provided that coordinates of the tip of the pen 3 can be calculated. Alternatively, a method such as light modulation may be employed as needed.

In Embodiment 1, the writing instrument 7 (e.g., a pencil lead or a ballpoint pen ink core) is provided at the tip of the pen 3 as a tip member which transmits vibration when in contact with the writing medium 6. Note, however, that the tip member at the tip of the pen 3 is not limited to the above, provided that the tip member is capable of handwriting and transmitting vibration when in contact with the writing medium 6.

### Embodiment 2

The following description will discuss Embodiment 2 of the present invention with reference to FIGS. 15 through 18. Embodiment 2 is different from Embodiment 1 in that a pen 3b of a pen tablet system of Embodiment 2 includes (i) a display section 21, (ii) a next-page switch/transmission switch 22, (iii) a previous-page switch 23, and (iv) a data compression section (not illustrated) which detects movement of the pen 3b and generates compressed information of the movement of the pen 3b. Embodiment 2 is identical with Embodiment 1 except for the points mentioned above. For convenience of description, members which have functions identical with those illustrated in the drawings of Embodiment 1 are given identical reference numerals, and are not described repeatedly.

FIG. 15 is a view showing how compressed data is generated, by the data compression section (e.g., a data compression section that can be provided in the CPU 19 illustrated in FIG. 12) which detects the movement (gesture) of the pen 3b and generates compressed information indicative of the movement of the pen 3b, from (i) data of the coordinates for each frame and (ii) data, for each frame, of a valid detection flag which indicates validity of detection ((i) and (ii) are shown in FIG. 14).

The compressed data is generated in the following manner. As shown in FIG. 15, the movement (gesture) of the pen 3b is detected on the basis of the coordinates calculated as in FIG. 14, and the following gesture event information is generated: an event indicating that the tip of the pen 3b has made contact with the writing medium (touch down), an event indicating that the tip of the pen 3b has been released from the writing medium (touch up), and an event indicating that the tip of the pen 3b is moving (movement). The compressed data is then stored in the coordinate storage section 10.

Although there are pieces of gesture event information for respective frames, it is possible to compress such information (generated data) by detecting the movement (gesture) of the pen 3b.

The reason why the generated data is compressed by detecting the movement (gesture) of the pen 3 is discussed as below with an example.

Refer to FIG. 15. In a case where valid coordinates are detected in three consecutive frames (for example, as in T3 to T5) and the movement of the coordinates is within a certain range, the tip of the pen 3b is considered to have made contact with the writing medium. Then, an event (touch down event) is generated.

Next, in a case where the movement of the tip of the pen 3b exceeds the certain range in T5 to T6, a movement event is generated. In a case where the movement of the tip of the pen 3b is small in T6 to T7, no event is generated.

In a case where the movement of the tip of the pen 3b exceeds the certain range in T7 to T8, a movement event is generated again.

Then, in a case where no valid coordinates are detected in three consecutive frames (as in T10 to T12), the pen 3b is considered to have been released from the writing medium in T9. Then, a touch up event is generated.

Furthermore, in a case where valid coordinates are detected in three consecutive frames (as in T16 to T18) and the movement of the coordinates is within the certain range, the tip of the pen 3b is considered to have made contact with the writing medium. Then, an event (touch down event) is generated again.

In a case where the movement of the tip of the pen 3b exceeds the certain range in T19 to T20, a movement event is generated again.

As described above, by obtaining data of the coordinates, frames and gesture events (gesture codes) (these are shown in FIG. 15) from the data of coordinates and valid detection flags indicative of validity of detection for respective frames (these are shown in FIG. 14), with detection of the movement (gesture) of the pen 3b, it is possible to obtain the compressed data of the movement of the pen 3b. The compressed data is stored in the coordinate storage section 10.

FIG. 16 is an external view of the pen 3b for use in the pen tablet system in accordance with Embodiment 2.

As illustrated in FIG. 16, the pen 3b has the next-page switch/transmission switch 22 provided in an end portion opposite to a tip portion where the writing instrument 7 is provided.

The pen 3b further has the previous-page switch 23 and the display section 21 near the next-page switch/transmission switch 22. The display section 21 shows the page number of a current page

The pen 3b is configured such that, when the next-page switch/transmission switch 22 is pressed for a short period of time, the page number of the current page (Page 2) is incremented and the page number thus incremented is displayed on the display section 21.

Meanwhile, as shown in FIG. 17, event information indicative of the new page number (Page 2) is added after the gesture event as described in FIG. 15.

Furthermore, when the previous-page switch 23 is pressed for a short period of time, the page number of the current page (Page 2) is decremented and the page number thus decremented is displayed on the display section 21. With this arrangement, for example, even when handwriting is being carried out on the current page (Page 2), it is possible to return to a previous page (Page 1) and carry out handwriting again on the previous page.

In a case where all coordinate data recorded on the new page are desired to be deleted, the next-page switch/transmission switch 22 and the previous-page switch 23 should be pressed and held down (for example, for two or more seconds) at the same time. With this, it is possible to delete all the data recorded on a desired page.

When the next-page switch/transmission switch 22 is pressed for a somewhat long period of time (for example, for two or more seconds), the compressed data stored in the coordinate storage section 10, which compressed data includes the event information indicative of the page number as above, is transmitted to, for example, the host computer 4 (external device) including a receiving section. The compressed data is caused, by the CPU 19, to be transmitted to the host computer 4 via the transmission section 11.

After receiving the compressed data, the host computer 4 decompresses, according to the order of pages, the compressed coordinate data and event information data for each page. In this way, an image handwritten with the use of the pen 3b is directly loaded into a memory of the host computer 4, and the image is displayed on a display section of the host computer 4.

According to the above configuration, by simply pressing and holding down the next-page switch/transmission switch 22, it is possible to view those handwritten with the pen 3b via the display section of the host computer 4.

Furthermore, according to the above configuration, the writing instrument 7 (e.g., a pencil lead or a ballpoint pen ink core) is provided at the tip of the pen 3b. This makes it possible to (i) write letters and drawings on a paper notebook or the like as with conventional writing tools while (ii) converting the letters and the drawings into electronic image data that look the same as the original letters and the drawings on the paper notebook or the like.

This eliminates the need for scanning the letters or the drawings on the paper notebook or the like with an optical scanner. Therefore, it becomes very convenient particularly in a case where a patient's chart, a nurse's record, or the like which is still not fully converted into electronic form is used as the writing medium 6.

Embodiment 2 dealt with an example case where compressed data includes both the event information indicative of the page number and the gesture event information. Note, however, that this does not imply any limitation. It is also possible to employ a configuration in which the compressed data includes only the event information indicative of the page number or only the gesture event information.

FIG. 18 is a flow chart of a main program of the CPU provided in the pen 3b of the pen tablet system in accordance with Embodiment 2.

As shown in FIG. 18, the program includes the following steps: a step of detecting a frame (S1); a step of calculating coordinates from four correlation values (S2); a step of detecting a gesture (S3); a step of storing gesture code/coordinates/frame time (S4); and a step of detecting switching and processing operation (S5). The flow of the steps is carried out in synchronization with the frame time.

The following description will discuss each of the steps.

In the step of detecting a frame (S1), in the main program, a frame signal is checked (the frame signal is a signal which is generated by a timer generating circuit in the CPU. The signal is usually 0, becomes 1 when one frame time has passed, and then returns to 0). If the frame signal is 0, the frame signal is checked again. When the frame signal has become 1, it is determined that “the frame is detected,” and then the process proceeds to a next step.

In the step of calculating coordinates from four correlation values (S2), the coordinates are calculated from the four correlation values stored in the respective resistors 18a, 18b, 18c, and 18d (see FIG. 12) in accordance with the foregoing algorithm.

In the step of detecting a gesture (S3), the following gestures are detected on the basis of (i) the coordinates detected in step S2 and (ii) previously detected coordinates and frame time: gestures such as “touch up,” “touch down,” and “movement”.

In the step of storing gesture code (gesture event)/coordinates/frame time (S4), information obtained in step S3 (i.e., type of the gesture and coordinates of the gesture, and frame information as shown in FIG. 15) is stored in the coordinate storage section 10.

Finally, in the step of detecting switching and processing operation (S5), which switch(s) (the next-page switch/transmission switch 22 and/or the previous-page switch 23) is/are pressed is detected. Then, a state is changed to another state that is to be realized when the switch(s) is/are pressed.

### Embodiment 3

The following description will discuss Embodiment 3 of the present invention with reference to FIGS. 19 through 21. Embodiment 3 is different from Embodiment 1 in that (i) an ultrasonic transmission sheet 2a of a pen tablet system of Embodiment 3 includes a start pulse modulation circuit 40 and a transmitting circuit 41 for synchronization between two ultrasonic emitters 5a and 5b and an ultrasonic detector 8 provided in a pen 3c and (ii) the pen 3c includes a receiving circuit 42 and a synchronization detection circuit 43 for synchronization between the pen 3c and the ultrasonic emitters 5a and 5b. Other configurations of Embodiment 3 are the same as those described in Embodiment 1. For convenience of description, members which have functions identical with those illustrated in the drawings of Embodiment 1 are given identical reference numerals, and are not described repeatedly.

FIG. 19 is a view schematically illustrating a configuration of the ultrasonic transmission sheet 2a and the pen 3c of the pen tablet system in accordance with Embodiment 3.

As illustrated in FIG. 19, the ultrasonic transmission sheet 2a has an ultrasonic emitter 5a at its upper left and an ultrasonic emitter 5b at its upper right.

The ultrasonic emitters 5a and 5b are configured to operate in response to two independent pseudo-random signals generated by two pseudo-random signal generating circuits 14a and 14b, respectively.

As illustrated in FIG. 19, the ultrasonic emitter 5a receives a PRN1-sequence pseudo-random signal obtained in the pseudo-random signal generating circuit 14a (illustrated in FIG. 5) in which the second Q output terminal (TAP number) and the sixth Q output terminal (TAP number) are selected.

The ultrasonic emitter 5b receives a PRN2-sequence pseudo-random signal obtained in the pseudo-random signal generating circuit 14b in which the third Q output terminal (TAP number) and the seventh Q output terminal (TAP number) are selected.

The ultrasonic transmission sheet 2a is provided with (i) the start pulse modulation circuit 40 which generates a synchronizing signal for synchronization between the ultrasonic emitters 5a and 5b and the ultrasonic detector 8 of the pen 3c and (ii) the transmitting circuit 41 which transmits a radio wave (the synchronizing signal) to the receiving circuit 42 of the coordinate detection circuit 9 provided in the pen 3c.

Note that the writing instrument 7 used in Embodiment 3 is a ballpoint pen ink core which does not change in length even when used. Note, however, that this does not imply any limitation. A pencil lead or the like which changes in length when used can also be used.

FIG. 20 is a view schematically illustrating a configuration of a part of the coordinate detection circuit 9 provided in the pen 3c. In this part, a cross-correlation between (i) a signal obtained in the ultrasonic detector 8 provided in the pen 3c and (ii) a corresponding one of the PRN1 and PRN2-sequence pseudo-random signals (described earlier) is obtained, and a time Ti (i=1, 2) at which a correlation value reaches a peak is obtained.

As illustrated in FIG. 20, the A/D converter 15 is connected to input terminals of respective two correlators 17a and 17b. Furthermore, outputs of respective two C/A code generators 16a and 16b are connected to the respective input terminals of the two correlators 17a and 17b.

The C/A code generator 16a has the same configuration as that of the pseudo-random signal generating circuit 14a in which the second Q output terminal (TAP number) and the sixth Q output terminal (TAP number) are selected (see FIG. 5). A PRN1-sequence pseudo-random signal outputted from the C/A code generator 16a is applied to the correlator 17a.

The C/A code generator 16b has the same configuration as that of the pseudo-random signal generating circuit 14b in which the third Q output terminal (TAP number) and the seventh Q output terminal (TAP number) are selected. A PRN2-sequence pseudo-random signal outputted from the C/A code generator 16b is applied to the correlator 17b.

The coordinate detection circuit 9a provided in the pen 3c includes (i) the receiving circuit 42 which receives a radio wave (a synchronizing signal) which is transmitted from the transmitting circuit 41 provided to the ultrasonic transmission sheet 2a for synchronization between the ultrasonic emitters 5a and 5b and the pen 3c and (ii) the synchronization detection circuit 43 which detects the synchronizing signal.

When the synchronizing signal is detected in the synchronization detection circuit 43, a start pulse signal SP is generated. In each of the correlators 17a and 17b, the time Ti (i=1, 2), which is the time from when the start pulse signal SP is generated to when a correlation value reaches a peak in the each of the correlators 17a and 17b, is measured.

The following description will discuss (i) how to calculate the time Ti (i=1, 2) at which a correlation value reaches a peak and (ii) how to detect coordinates in the present embodiment.

In Embodiment 3, a ballpoint pen ink core which does not change in length even when used is used as the writing instrument 7. Therefore, a distance from the tip of the pen 3c to the ultrasonic detector 8 can be considered as a fixed value. Furthermore, since the ultrasonic emitters 5a and 5b operate in synchronization with the ultrasonic detector 8, it is possible to detect the coordinates of the tip of the pen 3c even in a case where the ultrasonic transmission sheet 2a has only two ultrasonic emitters 5a and 5b.

In a case where the ultrasonic emitters 5a and 5b operate in synchronization with the ultrasonic detector 8, a₀ is 0 in the equations (1), (2), and (4) described in Embodiment 1. Furthermore, since the distance from the tip of the pen 3c to the ultrasonic detector 8 can be considered as a fixed value, r₀ is a fixed value.

FIG. 21 is a plan view of the ultrasonic transmission sheet 2a, in which the ultrasonic emitter 5a has the coordinates (x1, y1) and the ultrasonic emitter 5b has the coordinates (x2, y2).

In the same manner as in Embodiment 1, a correlation between (i) a signal U(t) obtained in the ultrasonic detector 8 in the pen 3c and (ii) a corresponding Gold sequence mi(t) is obtained, and the time (delay time) Ti (i=1, 2) at which a correlation value reaches a peak is obtained.

In this way, the following two kinds of equation (14), which correspond to the respective times Ti (i=1, 2), are obtained:

[Math. 10]

Tᵢ×c=\sqrt{(xᵢ−x)²+(yᵢ−y)²}+r₀ (i=1,2) Equation (14)

Since the equation (14) has two unknowns x and y, the coordinates can be determined by the least squares method.

In the equation (14), “Ti×c” is replaced with a pseudo-measured distance Ri. Then, the Newton's method is used to find true coordinates through the two kinds of equation (14) (wherein i=1, 2) by the least squares method.

The following description will specifically discuss a calculation by the Newton's method.

First, the “Ti×c” in the equation (14) is replaced with the pseudo-measured distance Ri, and a partial derivative of the equation (14) is calculated. In this way, the following equation (15) is obtained:

$$\begin{matrix}[ Math . 11 ] & \\ Δ {R}_{i} = \frac{δ {R}_{i}}{δ x} Δ x + \frac{δ {R}_{i}}{δ y} Δ y & Equation ( 15 )\end{matrix}$$

Then, the following equations (16) and (17) are obtained from the equation (14):

$$\begin{matrix}[ Math . 12 ] & \\ \frac{δ {R}_{i}}{δ x} = \frac{- ( {x}_{i} - x )}{\sqrt{{( {x}_{i} - x )}^{2} + {( {y}_{i} - y )}^{2}}} & Equation ( 16 ) \\ [ Math . 13 ] & \\ \frac{δ {R}_{i}}{δ y} = \frac{- ( {y}_{i} - y )}{\sqrt{{( {x}_{i} - x )}^{2} + {( {y}_{i} - y )}^{2}}} & Equation ( 17 )\end{matrix}$$

Assuming that the equations (16) and (17) are αi and βi, respectively, the following equation (18) is obtained. In the equation (18), εi are errors.

$$\begin{matrix}[ Math . 14 ] & \\ ( \begin{matrix}Δ {R}_{1} \\ Δ {R}_{2}\end{matrix} ) = ( \begin{matrix}α1 & β1 \\ α2 & β2\end{matrix} ) ( \begin{matrix}Δ x \\ Δ y\end{matrix} ) + ( \begin{matrix}ɛ1 \\ ɛ2\end{matrix} ) & Equation ( 18 )\end{matrix}$$

The equation (18) can be represented by the following vector equation (19):

R=A·X+E Equation (19)

Assume that f is the sum of squared errors. When f is represented by the equation (19), the following equation (20) is obtained:

$$\begin{matrix}f = {E}^{T} \cdot E \\ = {( R \text{-} A \cdot X )}^{T} ( R \text{-} A \cdot X ) \\ = {R}^{T} R \text{-} 2 {R}^{T} AX + {X}^{T} ( {A}^{T} A ) X\end{matrix} \qquad Equation ( 20 )$$

It is only necessary to find X so that f is minimum.

Note that the superscript T indicates a transposed matrix.

The equation (20) is partially differentiated with respect to X and is replaced by 0, whereby the following equation (21) is obtained:

δf/δX=−2R^{T}·A+2X^{T}(A^{T}A)=0Equation (21)

Finally, the following equation (22) is obtained from the equation (21):

X=(A^{T}A)⁻¹A^{T}·R Equation (22)

where the superscript −1 indicates an inverse matrix.

The following description will discuss a calculation procedure carried out to find coordinates by the Newton's method.

First, coordinates (xi, yi) (i=1, 2) of each of the two ultrasonic emitters 5a and 5b and initial values (x0, y0) of (x, y) are substituted into the equations (16) and (17) to obtain αi and βi. This gives a matrix A.

Next, each of the two Ti values obtained from the correlation measurement is multiplied by c. This gives a vector R (Ri).

Then, from the matrix A and the vector R thus obtained, X is obtained through the equation (22).

Since the X is “Δx and Δy” in the equation (18), the initial values (x0, y0) are replaced with (x0+Δx, y0+Δy). Then, the above-mentioned calculation procedure is repeated several times until the coordinates (x, y) converge. As a result, the coordinates (x, y) of the tip of the pen 3c are obtained.

In Embodiment 3, two ultrasonic emitters are used. Note, however, that the number of the ultrasonic emitters is not limited to two, provided that the number of the ultrasonic emitters is not less than two. The number of the ultrasonic emitters can be determined as appropriate in consideration of a desired accuracy of coordinate detection and the like.

The pen tablet device of the present invention is preferably arranged such that the three or more vibration emitters are provided in positions in each of which edges of the holder intersect each other.

According to the arrangement, the coordinates of the tip of the pen can be detected with high accuracy even in a case where a small number of the vibration emitters are used.

The pen tablet device of the present invention is preferably arranged such that the three or more vibration emitters are ultrasonic emitters; and the vibration detector is an ultrasonic detector.

According to the arrangement, the coordinates of the tip of the pen are detected with the use of ultrasonic waves. This makes it possible to provide a pen tablet device having high accuracy and reliability.

The pen tablet device of the present invention is preferably arranged such that the pen includes a memory that is capable of storing information indicative of the coordinates of the tip of the pen.

According to the arrangement, the pen includes the memory capable of storing the information indicative of the coordinates of the tip of the pen. This makes it possible to read out and use the information indicative of the coordinates of the tip of the pen from the pen when necessary.

The pen tablet device of the present invention is preferably arranged such that the pen includes a processing section for causing the information indicative of the coordinates of the tip of the pen to be stored in the memory.

The pen tablet device of the present invention is preferably arranged such that the information indicative of the coordinates of the tip of the pen includes information on whether or not the tip of the pen has made contact with the writing medium; the processing section of the pen includes a data compression section for generating compressed information indicative of movement of the pen, by detecting the movement of the pen on the basis of (i) the information on whether or not the tip of the pen had made contact with the writing medium and/or (ii) amount of change in the coordinates of the tip of the pen; and the compressed information generated by the data compression section is stored in the memory.

According to the arrangement, the processing section of the pen includes the data compression section which detects the movement of the pen and generates the compressed information indicative of the movement of the pen. The compressed information thus generated by the data compression section is stored in the memory. This reduces the amount of the information indicative of the coordinates of the tip of the pen to be stored in the memory.

The pen tablet device of the present invention is preferably arranged such that the pen includes a next-page switch; and every time the next-page switch is pressed, the processing section adds new page information to an end of the information indicative of the coordinates of the tip of the pen.

According to the arrangement, the information indicative of the coordinates of the tip of the pen can be stored, for each page, by pressing the next-page switch every time a page of the writing medium (e.g., paper or a notebook) placed on the holder goes to a next page.

The pen tablet device of the present invention is preferably arranged such that the pen includes a previous-page switch; and when the previous-page switch is pressed, the processing section adds new coordinates of the tip of the pen to information indicative of coordinates of the tip of the pen which information corresponds to a previous page preceding a current page.

According to the arrangement, new coordinates of the tip of the pen can be added to the information indicative of the coordinates of the tip of the pen, which information corresponds to the previous page preceding the current page. This makes it easy to add handwriting to the previous page.

The pen tablet device of the present invention is preferably arranged such that the pen includes a switch for deleting, from the memory, information indicative of coordinates of the tip of the pen which information corresponds to the current page.

According to the arrangement, even in a case where a mistake is made in handwriting on a current page, the information indicative of the coordinates of the tip of the pen on the current page can be deleted from the memory by pressing the switch.

The pen tablet device of the present invention is preferably arranged such that the pen includes a display section for displaying a page number.

According to the arrangement, the display section of the pen displays the current page number. This makes it possible to prevent a user from forgetting to press the next-page switch when a page of the paper or the notebook goes to a next page.

The pen tablet device of the present invention is preferably arranged such that the tip member is a writing instrument capable of writing on the writing medium.

According to the arrangement, the pen includes, at the tip, the writing instrument (e.g., a pencil lead or a ballpoint pen ink core) so that the pen is capable of handwriting on the writing medium (e.g., paper or a notebook), which is placed on the holder, by bringing the tip member into contact with the writing medium. This enables handwriting on the writing medium.

The pen tablet system of the present invention is preferably arranged such that the pen includes (i) a memory capable of storing the information indicative of the coordinates of the tip of the pen and (ii) a transmission switch for transmitting the information indicative of the coordinates of the tip of the pen; and when the transmission switch is pressed, the information indicative of the coordinates of the tip of the pen is transmitted from the transmitting section.

According to the arrangement, the pen includes (i) the memory capable of storing the information indicative of the coordinates of the tip of the pen and (ii) the transmission switch for transmitting the information indicative of the coordinates of the tip of the pen. This makes it possible, by pressing the transmission switch only when necessary, to transmit, to the processing device, the information indicative of the coordinates of the tip of the pen detected in the pen.

The pen tablet system of the present invention is preferably arranged such that the processing device includes a display section.

According to the arrangement, an image based on the information indicative of the coordinates of the tip of the pen detected in the pen can be viewed via the display section of the processing device.

### INDUSTRIAL APPLICABILITY

The present invention is suitably applicable, for example, to (i) a pen tablet device capable of detecting coordinates of a tip of a pen and (ii) a pen tablet system which includes the pen tablet device.

### REFERENCE SIGNS LIST

1: Pen tablet system
2, 2a: Ultrasonic transmission sheet (holder)
3, 3a, 3b, 3c: Pen
4: Host computer (processing device)
5a, 5b, 5c, 5d: Ultrasonic emitter (vibration emitter)
6: Writing medium
7: Writing instrument (tip member)
8: Ultrasonic detector (vibration detector)
9: Coordinate detection circuit
10: Coordinate storage section (memory)
11: Transmitting section
12: First shift register
13: Second shift register
14a, 14b, 14c, 14d: Pseudo-random signal generating circuit
15: A/D converter
16a, 16b, 16c, 16d: C/A code generator
17a, 17b, 17c, 17d: Correlator
18a, 18b, 18c, 18d: Resistor
19: CPU (processing section)
20: Software storage section
21: Display section
22: Page forward/transmission switch
23: Previous-page switch
24: Timer circuit section

1. A pen tablet device, comprising:
a pen; and
a holder,
said pen tablet device being capable of detecting coordinates of a tip of the pen,
the pen (i) including a vibration detector and (ii) including, at the tip, a tip member which transmits vibration while in contact with a writing medium placed on the holder,
the holder having, at its corners, three or more vibration emitters which emit respective independent pseudo-random signals,
the vibration detector detecting vibrations which (i) are emitted from the respective three or more vibration emitters and (ii) are transmitted to the pen via the holder and the writing medium while the tip of the pen is in contact with the writing medium, and
said pen tablet device (i) carrying out a calculation to find a correlation between each of signals based on the respective vibrations detected by the vibration detector and a corresponding one of the independent pseudo-random signals to thereby find a delay time for a corresponding one of the three or more vibration emitters and (ii) finding the coordinates of the tip of the pen from the delay time.

2. The pen tablet device as set forth in claim 1, wherein the three or more vibration emitters are provided in positions in each of which edges of the holder intersect each other.

3. The pen tablet device as set forth in claim 1, wherein:
the three or more vibration emitters are ultrasonic emitters; and
the vibration detector is an ultrasonic detector.

4. The pen tablet device as set forth in claim 1, wherein the pen includes a memory that is capable of storing information indicative of the coordinates of the tip of the pen.

5. The pen tablet device as set forth in claim 4, wherein the pen includes a processing section for causing the information indicative of the coordinates of the tip of the pen to be stored in the memory.

6. The pen tablet device as set forth in claim 5, wherein:
the information indicative of the coordinates of the tip of the pen includes information on whether or not the tip of the pen has made contact with the writing medium;
the processing section of the pen includes a data compression section for generating compressed information indicative of movement of the pen, by detecting the movement of the pen on the basis of (i) the information on whether or not the tip of the pen had made contact with the writing medium and/or (ii) amount of change in the coordinates of the tip of the pen; and
the compressed information generated by the data compression section is stored in the memory.

7. The pen tablet device as set forth in any one of claim 5, wherein:
the pen includes a next-page switch; and
every time the next-page switch is pressed, the processing section adds new page information to an end of the information indicative of the coordinates of the tip of the pen.

8. The pen tablet device as set forth in claim 5, wherein:
the pen includes a previous-page switch; and
when the previous-page switch is pressed, the processing section adds new coordinates of the tip of the pen to information indicative of coordinates of the tip of the pen which information corresponds to a previous page preceding a current page.

9. The pen tablet device as set forth in claim 5, wherein the pen includes a switch for deleting, from the memory, information indicative of coordinates of the tip of the pen which information corresponds to the current page.

10. The pen tablet device as set forth in claim 7, wherein the pen includes a display section for displaying a page number.

11. A pen tablet device, comprising:
a pen; and
a holder,
said pen tablet device being capable of detecting coordinates of a tip of the pen,
the pen (i) including a vibration detector and (ii) including, at the tip, a tip member which transmits vibration while in contact with a writing medium placed on the holder,
the holder having, at its corners, a plurality of vibration emitters which emit respective independent pseudo-random signals,
the vibration detector detecting vibrations which (i) are emitted from the respective plurality of vibration emitters and (ii) are transmitted to the pen via the holder and the writing medium while the tip of the pen is in contact with the writing medium,
a start pulse signal for the plurality of vibration emitters being in synchronization with a start pulse signal for the vibration detector, and
said pen tablet device (i) carrying out a calculation to find a correlation between each of signals based on the respective vibrations detected by the vibration detector and a corresponding one of the independent pseudo-random signals to thereby find a delay time for a corresponding one of the plurality of vibration emitters and (ii) finding the coordinates of the tip of the pen from the delay time.

12. The pen tablet device as set forth in claim 1, wherein the tip member is a writing instrument capable of writing on the writing medium.

13. A pen tablet system, comprising:
a pen tablet device recited in claim 1; and
a processing device for processing information indicative of coordinates of the tip of the pen,
the pen of the pen tablet device including a transmitting section for transmitting the information indicative of the coordinates of the tip of the pen, and
the processing device including a receiving section for receiving the information indicative of the coordinates of the tip of the pen which information is transmitted from the transmitting section.

14. The pen tablet system as set forth in claim 13, wherein:
the pen includes (i) a memory capable of storing the information indicative of the coordinates of the tip of the pen and (ii) a transmission switch for transmitting the information indicative of the coordinates of the tip of the pen; and
when the transmission switch is pressed, the information indicative of the coordinates of the tip of the pen is transmitted from the transmitting section.

15. The pen tablet system as set forth in claim 13, wherein the processing device includes a display section.
